(19) United States
(12) Patent Application Publication
(10) Pub. No.: US 2026/0162016 A1
(43) Pub. Date: Jun. 11, 2026

(54) METHODS AND SYSTEMS FOR REFINING A TRAINING DATASET FOR TRAINING A MACHINE LEARNING MODEL

(71) Applicant: Mastercard International Incorporated, Purchase, NY (US)

(72) Inventors: Govind Vitthal Waghmare, Pune (IN); Siddhartha Asthana, New Delhi (IN); Sonia Gupta, Gurgaon (IN); Vennela Yarabolu, Hyderabad (IN)

(21) Appl. No.: 19/408,912

(22) Filed: Dec. 4, 2025

(30) Foreign Application Priority Data
Dec. 7, 2024 (IN) 202441096819

(51) Int. Cl. G06N 20/00

(52) U.S. Cl. CPC G06N 20/00

(57) ABSTRACT

Methods and server systems for refining a training dataset for training a Machine Learning (ML) model are described herein. Method performed by a server system includes accessing multiple data segments, each data segment including a subset of training samples of training dataset. Method includes computing, by a first prediction model, gradient scores for each data segment indicating a concept drift-based relevancy of a particular data segment among multiple data segments. Method includes filtering multiple data segments to obtain filtered data segments based on the gradient scores and gradient thresholds. Method includes determining, by a second prediction model, a top-ranked batch set based on multiple data segments, a test dataset, and a refining condition. Method includes generating a refined training dataset, including a set of relevant training batches based on the filtered data segments, and the top-ranked batch set to train the ML model for obtaining a trained ML model.

### TECHNICAL FIELD

The present disclosure relates to the field of artificial intelligence-based processing systems and, more particularly, to electronic methods and complex processing systems for refining a training dataset for training a Machine Learning (ML) model.

### BACKGROUND

With the advent of technology, Artificial Intelligence (AI) or Machine Learning (ML) models or algorithms have been used in almost every field, such as healthcare, education, finance, etc., among other fields. Such models are used to perform a variety of tasks, such as classification tasks, anomaly detection, pattern recognition, speech recognition, and so on. The classification tasks can be speech recognition, image classification, fraud detection, medical diagnostic testing, email spam detection, etc., among other classification tasks. However, the constant evolution of real-time datasets used during the real-time deployment of the ML models, over time, poses a challenge to them in terms of generating appropriate predictions and model performance. Even continuous machine learning (CML) systems pose several drawbacks. One of the drawbacks is data drift, which is a situation where differences between past training data and future test data cause major drops in model performance and efficiency. If the distribution of input features changes between training and test datasets, while their relationship with the target variable remains the same, a covariate shift has occurred. On the other hand, if the relationship between input features and the target variable evolves over time, a concept drift has occurred.

To eliminate such issues, over the years, several approaches have been developed. However, most of these existing conventional approaches have several drawbacks. Most of the conventional approaches typically update models using ensemble techniques, often discarding drifted historical data and focusing primarily on either covariate drift or concept drift. These conventional approaches face issues such as high resource demands, inability to manage all types of drifts effectively, and neglecting the valuable context that historical data can provide. It may be understood that while addressing data drift is essential to preserving the dependability and effectiveness of ML systems, conventional approaches frequently fail in a number of ways. Reiterating, conventional approaches usually focus on either covariate or concept drift, often neglecting comprehensive solutions and discarding valuable historical data.

Thus, a technological need exists for improved methods and systems for refining a training dataset for training the ML model.

### BRIEF SUMMARY

Various embodiments of the present disclosure provide systems and methods for refining a training dataset for training a Machine Learning (ML) model.

In an embodiment, a computer-implemented method for refining a training dataset for training a Machine Learning (ML) model is disclosed. The computer-implemented method performed by a server system includes accessing a plurality of data segments from the training dataset. Each data segment includes a subset of training samples associated with a training dataset. Each training sample is associated with a training feature set. Further, the computer-implemented method includes computing, by a first prediction model executed by the server system, a set of gradient scores for each data segment based, at least in part, on the training feature set associated with each training sample in each data segment and a test dataset. The computer-implemented method further includes filtering the plurality of data segments to obtain a set of filtered data segments based, at least in part, on the set of gradient scores and a set of gradient thresholds. Each gradient score indicates a concept drift-based relevancy of a particular data segment among the plurality of data segments. Then, the computer-implemented method includes determining, by a second prediction model executed by the server system, a top-ranked batch set based, at least in part, on the plurality of data segments and the test dataset. Each data segment includes a subset of batches. The top-ranked batch set includes one or more batches ranked based on the refining condition. Thereafter, the computer-implemented method includes generating a refined training dataset including a set of relevant batches based, at least in part, on the set of filtered data segments and the top-ranked batch set. The refined training dataset is used for training the ML model.

In another embodiment, a server system is disclosed. The server system includes a communication interface and a memory including executable instructions. The server system also includes a processor communicably coupled to the memory. The processor is configured to execute the instructions to cause the server system, at least in part, to access a plurality of data segments from the training dataset. Each data segment includes a subset of training samples associated with a training dataset. Each training sample is associated with a training feature set. Then, the server system is caused to compute a set of gradient scores for each data segment based, at least in part, on the training feature set associated with each training sample in each data segment and a test dataset. Each gradient score indicates a concept drift-based relevancy of a particular data segment among the plurality of data segments. The server system computes the set of gradient scores using a first prediction model executed by the server system. Thereafter, the server system is caused to filter the plurality of data segments to obtain a set of filtered data segments based, at least in part, on the set of gradient scores and a set of gradient thresholds. The server system is further caused to determine a top-ranked batch set based, at least in part, on the plurality of data segments and the test dataset. Each data segment includes a subset of batches. The top-ranked batch set includes one or more batches ranked based on the refining condition. The server system determines the top-ranked batch set using a second prediction model executed by the server system. Then, the server system is caused to generate a refined training dataset including a set of relevant batches based, at least in part, on the set of filtered data segments and the top-ranked batch set. The refined training dataset is used for training an ML model.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a plurality of data segments from the training dataset. Each data segment includes a subset of training samples associated with a training dataset. Each training sample is associated with a training feature set. Further, the method includes computing, by a first prediction model executed by the server system, a set of gradient scores for each data segment based, at least in part, on the training feature set associated with each training sample in each data segment and a test dataset. Each gradient score indicates a concept drift-based relevancy of a particular data segment among the plurality of data segments. The method further includes filtering the plurality of data segments to obtain a set of filtered data segments based, at least in part, on the set of gradient scores and a set of gradient thresholds. Then, the method includes determining, by a second prediction model executed by the server system, a top-ranked batch set based, at least in part, on the plurality of data segments and the test dataset. Each data segment includes a subset of batches. The top-ranked batch set includes one or more batches ranked based on the refining condition. Thereafter, the method includes generating a refined training dataset including a set of relevant batches based, at least in part, on the set of filtered data segments and the top-ranked batch set. The refined training dataset is used for training an ML model.

### BRIEF DESCRIPTION OF THE FIGURES

For a more complete understanding of example embodiments of the present technology, reference is now made to the following descriptions taken in connection with the accompanying drawings, in which:

FIG. 1 illustrates an example representation of an environment related to at least some example embodiments of the present disclosure;

FIG. 2 illustrates a simplified block diagram of a server system, in accordance with an embodiment of the present disclosure;

FIG. 3 illustrates a schematic representation of an architecture for refining a training dataset for training a Machine Learning (ML) model, in accordance with an embodiment of the present disclosure;

FIG. 4 illustrates a schematic representation of a process of filtering data segments, in accordance with an embodiment of the present disclosure;

FIG. 5 illustrates a schematic representation of a process of determining a covariate shift ranking of a set of training batches, in accordance with an embodiment of the present disclosure;

FIG. 6A illustrates a graphical representation depicting an effect of varying percentages of data used for training on an accuracy of the ML model for an example training dataset, in accordance with an embodiment of the present disclosure;

FIG. 6B illustrates a graphical representation depicting an effect of varying percentages of data used for training on an accuracy of the ML model, for another example training dataset, in accordance with an embodiment of the present disclosure;

FIG. 7A illustrates a tabular representation 700 of experimental results for synthetic datasets, in accordance with an embodiment of the present disclosure;

FIG. 7B illustrates a tabular representation 710 of experimental results for real-world datasets, in accordance with an embodiment of the present disclosure;

FIG. 8 illustrates a flow diagram depicting a method for refining a training dataset for training an ML model, in accordance with an embodiment of the present disclosure;

FIG. 9 illustrates a flow diagram depicting a process of generating a refined training dataset, in accordance with an embodiment of the present disclosure; and

FIG. 10 illustrates a flow diagram depicting a method for refining a training dataset for training an ML model, in accordance with an embodiment of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Conditional language such as, among others, “can”, “could”, “might”, or “may”, unless specifically stated otherwise, are otherwise understood within the context as used in general to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a server system configured to” are intended to include one or more recited server systems/processors. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations” without other modifiers, typically means at least two recitations or two or more recitations).

It will be understood by those within the art that, in general, terms used herein, are generally intended as “open” terms (e.g., the term “including” or “comprising” should be interpreted as “including/comprising but not limited to,” the term “having” should be interpreted as “having at least,” the term “includes” or “comprises” should be interpreted as “includes/comprises but is not limited to,” etc.). Also, the terms “based on”, “based, at least in part, on”, “based at least on”, and similar expressions may be used interchangeably throughout the description, unless otherwise specified. These terms are intended to convey that a particular feature, step, or determination is derived from, influenced by, or dependent upon one or more factors, and do not exclude the possibility that additional factors may also contribute.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the terms “cardholder”, “user”, “account holder”, “consumer”, and “buyer” are used interchangeably throughout the description and refer to a person who has a payment account or at least one payment card (e.g., credit card, debit card, etc.). The payment card may or may not be associated with the payment account and will be used by a merchant or a beneficiary to complete the payment transaction initiated by the cardholder. The payment account may be opened via an issuing bank or an issuer server.

The term “payment account” used throughout the description refers to a financial account that is used to fund a financial transaction. Examples of financial accounts include, but are not limited to, a savings account, a credit account, a checking account, and a virtual payment account.

The terms “payment transaction”, “financial transaction”, “e-commerce transactions”, “digital transaction”, and “transaction” are used interchangeably throughout the description and refer to a transaction of payment of a certain amount being initiated by the cardholder.

The term “issuer”, used throughout the description, refers to a financial institution normally called an “issuer bank” or “issuing bank” in which an individual or an institution may have an account. The issuer also issues a payment card, such as a credit card, a debit card, etc. Further, the issuer may also facilitate online banking services, such as electronic money transfer, bill payment, etc., to the cardholders through a server, which is called the “issuer server” throughout the description.

The term “merchant”, used throughout the description, generally refers to a seller, a retailer, a purchase location, an organization, or any other entity that is in the business of selling goods or providing services, and it can refer to either a single business location or a chain of business locations of the same entity.

The term “acquirer”, used throughout the description, refers to a financial institution (e.g., a bank) that processes financial transactions for merchants. In other words, this can be an institution that facilitates the processing of payment transactions for physical stores, merchants, or institutions that own platforms that make either online purchases or purchases made via software applications possible (e.g., the shopping cart platform providers and the in-app payment processing providers).

The terms “payment network” and “card network” are used interchangeably throughout the description and refer to a network or collection of systems used for the transfer of funds using cash substitutes. Payment networks may use a variety of different protocols and procedures to process the transfer of money for several types of transactions. Payment networks are companies that connect an issuing bank with an acquiring bank or a beneficiary bank to facilitate online payment. It is to be noted that the payment networks are operated by organizations that are called “payment processors” throughout the description.

The terms “payment card” and “card” are used interchangeably throughout the description and refer to a physical or virtual card that may or may not be linked with a financial or payment account. It may be presented to a merchant, a beneficiary, or any such facility to fund a financial transaction via the associated payment account. Examples of payment cards include, but are not limited to, debit cards, credit cards, prepaid cards, virtual payment numbers, virtual card numbers, forex cards, charge cards, e-wallet cards, and stored-value cards.

The term “data drift” refers to a phenomenon where discrepancies between historical training data and future test data lead to significant performance degradation and operational inefficiencies of the model. Data drift can be of various types, such as concept drift, covariate drift, or the like. Concept drift happens when the relationship between input and output variables changes. Concept drift alters the underlying logic or patterns that the model has learned. On the other hand, covariate drift (otherwise also referred to as “covariate shift”) happens when input features go through a change of distribution. Covariate drift does not necessarily change the relationship between inputs and outputs, but the inputs evolve, making it harder for the model to predict outcomes reliably.

The term ‘set’ refers to a collection of well-defined, unordered objects called elements or members. For example, the phrases a ‘feature set’, and a ‘set of gradient scores’ refer to a collection of features and gradient scores, respectively.

### Overview

As described earlier, continuous machine learning (CML) systems have been adopted in real-world applications having constantly evolving real-time datasets, for generating accurate predictions and maintaining model performance. However, CML systems are associated with several drawbacks, such as the requirement to gather necessary data continuously is challenging, continuous re-training of the model consumes extensive resources and processing power, continuous maintenance and monitoring of models is expensive, and the like. Another important drawback is data drift, which is a phenomenon where discrepancies between historical training data and future test data lead to significant performance degradation and operational inefficiencies of the model. Data drift is classified into two main categories, such as a covariate shift and a concept drift.

Covariate shift occurs when the distribution of input features changes between training and test datasets, while their relationship with the target variable remains the same. This shift can result from environmental changes, data collection methods, sampling procedures, or other reasons. Conventionally, to address the covariate shift, several approaches have been implemented. One such approach includes reweighting training data. Another approach includes using domain adaptation methods to maintain model accuracy on new data. It is noted that a majority of the conventional approaches focus on training and test datasets without considering continuous time. Rather, conventional approaches address the issue of the covariate shift by modifying training objectives or adjusting the importance of the training data to improve test accuracy.

Further, concept drift occurs when the relationship between input features and the target variable evolves over time. This shift can happen gradually or suddenly, altering the underlying data patterns. As may be understood, concept drift challenges ML models by potentially decreasing their accuracy and reliability if not detected and addressed. To address the concept drift effectively, it is essential to continuously monitor model performance and update the model to adapt to new data patterns, ensuring sustained accuracy and relevance. Conventional approaches, such as periodic retraining and re-weighting recent data, are often ineffective, leading to accuracy drops and performance variations. Some of the other conventional approaches include window-based approaches, detection methods, and ensemble methods. The window-based approaches employ a sliding window of recent data for training updated models. The detection methods utilize statistical tests to identify the occurrence of data drift and trigger model retraining only when such shifts are detected. Further, the ensemble methods create ensembles of models trained on previous data, combining their predictions through a weighted average to maintain accuracy.

For instance, drift detection is crucial in environments where data distributions evolve. When drifts occur, the model performance can drop. In such environments, various drift detection techniques can be employed to identify drifts by pinpointing change points or time intervals. It is noted that effective conventional drift detection methods ensure that models remain accurate and relevant by signaling the need for retraining or adjustments, thereby allowing the model to adapt to the new data distribution. These conventional methods are broadly classified into supervised methods and unsupervised methods.

Some other conventional approaches, such as model-centric and data-centric approaches, address data drift differently. The model-centric approaches, such as retraining and online learning, adapt models to changing patterns, enhancing adaptability, but at high cost and complexity. Further, the data-centric approaches, such as subset selection and reweighting, ensure training data remains relevant, improving efficiency. The data-centric approaches have been developed to adapt to the concept drift. Data reduction techniques focus on cleaning data by removing noisy samples and features. Drift understanding techniques filter out obsolete data using the newest data segment as a pattern, based on cumulative distribution function comparisons. Once filtered out, samples are not reselected, even if they could be beneficial later. Another technique in this category aims to select samples that do not yield conflicting predictions between previous and current models. Moreover, combining both these approaches can manage the data drift effectively, balancing accuracy and resources that are required to maintain model reliability and performance in dynamic environments. This hybrid approach ensures models stay robust against evolving data trends over time, however, they still retain the drawback of being complex and expensive. Also, these techniques and all the conventional approaches share a fundamental limitation, i.e., they lack mechanisms to validate if the data preprocessing steps genuinely enhance model accuracy.

In addition, the conventional drift adaptation methods typically update models using ensemble techniques, often discarding drifted historical data and focusing primarily on either covariate drift or concept drift. These methods face issues such as high resource demands, inability to manage all types of drifts effectively, and neglecting the valuable context that historical data can provide. It may be understood that while addressing data drift is essential to preserving the dependability and effectiveness of ML systems, conventional approaches frequently fail in a number of ways. Conventional approaches usually focus on either covariate or concept drift, often neglecting comprehensive solutions and discarding valuable historical data.

To that end, various embodiments of the present disclosure provide methods, systems, electronic devices, and computer program products for refining a training dataset for training a Machine Learning (ML) model. The present disclosure describes a server system that is configured to access an entity-related dataset including information related to a plurality of entities from a database associated with the server system. Then, the server system generates a feature set for each data sample and stores the same in the database. In an embodiment, the server system accesses a training feature set corresponding to each training sample in a training dataset from the database. The training dataset may include a plurality of training samples corresponding to the plurality of entities. The server system may be configured to generate a plurality of training data segments (hereinafter, otherwise also referred to as a ‘plurality of data segments’, ‘training data segments’, or simply ‘data segments’) from the training dataset based, at least in part, on the training feature set. Herein, each data segment includes a subset of training samples associated with the training dataset. Then, the server system accesses the data segments from the database for computing a set of gradient scores for each data segment based, at least in part, on the training feature set associated with each training sample in each data segment and a test dataset. Each gradient score can indicate a concept drift-based relevancy of a particular data segment among the plurality of data segments. In an embodiment, the server system computes the gradient scores, including a disparity score and a gain score, using a first prediction model executed by the server system.

Further, in an embodiment, the server system is configured to filter the plurality of data segments to obtain a set of filtered data segments based, at least in part, on the set of gradient scores and a set of gradient thresholds. More specifically, the server system extracts a first subset of training data segments (hereinafter, otherwise also referred to as an ‘intermediate set of data segments’) from the plurality of training data segments based, at least in part, on the disparity score and the set of gradient thresholds. In a non-limiting implementation, the server system may extract the first subset of training data segments using one or more prediction models (such as the first prediction model) associated with the server system.

More specifically, to compute the disparity score for each data segment, the server system trains the first prediction model by iteratively performing a set of operations until predefined criteria are met. The first prediction model may be initialized by model parameters. The set of operations include: (i) computing a training gradient component for each training sample; (ii) computing a test gradient component for each test sample in the test dataset; (iii) computing the disparity score for each data segment based on the training gradient component, the test gradient component, and a disparity score computation function; and (iv) optimizing the model parameters based on backpropagation of the training gradient component.

In a non-limiting implementation, to compute the training gradient component, the server system is configured to generate an embedding for each training sample. Then, the first prediction model generates a probability score for each training sample based on the embedding. Herein, the probability score indicates a likelihood that the training sample belongs to a particular class label. Then, the first prediction model generates a prediction for each training sample based on the probability score. The prediction indicates a predicted class label of the training sample. Then, the server system computes a loss for each training sample based on the predicted class label and a true label. Then, the server system computes the training gradient component for each training sample based on the loss of the corresponding training sample.

On the other hand, to compute the test gradient component for each test sample, the server system generates an embedding for each test sample based on the test feature set associated with the corresponding test sample. Then, the first prediction model generates a probability score for each test sample based on the corresponding embedding. Herein, the probability score indicates a likelihood that the corresponding test sample belongs to a particular class label. The first prediction model generates a prediction for each test sample based on the corresponding probability score. The prediction indicates a predicted class label of the corresponding test sample. Then, the server system computes a loss for each test sample based on the corresponding predicted class label and a true label. The server system computes the test gradient component for each test sample based on the loss of the corresponding test sample.

Furthermore, the server system may extract a second subset of training data segments (or the set of filtered data segments) from the first subset of training data segments based, at least in part, on the gain score using the one or more prediction models such as the first prediction model. Herein, to compute the gain score, the server system accesses the intermediate set of data segments from the database. Then, the server system computes the gain score for each data segment of the intermediate set of data segments using the first prediction model. More specifically, to compute the gain score, the server system trains the first prediction model by iteratively performing a set of operations until predefined criteria are met. Herein, the first prediction model is again initialized by model parameters. The set of operations includes: (i) computing a training gradient component for each training sample; (ii) computing a test gradient component for each test sample in the test dataset; and (iii) computing the gain score for each data segment of the intermediate set of data segments based on the training gradient component, the test gradient component, and a gain score computation function.

In a non-limiting implementation, to filter the plurality of data segments for obtaining the set of filtered data segments, the server system accesses the disparity score for each data segment and selects one or more data segments from the plurality of data segments having the disparity score at least equal to a disparity threshold to obtain the intermediate set of data segments. Then, the server system accesses the gain score for each data segment of the intermediate set of data segments from the database and selects one or more data segments from the intermediate set of data segments having the gain score at least equal to a gain threshold to obtain the set of filtered data segments.

In addition, the server system determines a top-ranked batch set based, at least in part, on the plurality of data segments, the test dataset, and a refining condition. Herein, each data segment includes a subset of batches, and the top-ranked batch set includes one or more batches ranked based on the refining condition. Moreover, the server system may generate a refined training dataset based, at least in part, on the second subset of training data segments and the refining condition. The refined training dataset may include a set of relevant training batches extracted based on the second subset of training data segments, based on the refining condition. Herein, in a non-limiting implementation, as per the refining condition, the top-ranked batch set is determined. Thus, in other words, the server system generates the refined training dataset based on the set of filtered data segments and the top-ranked batch set. Further, the server system may be configured to train the ML model based, at least in part, on the refined training dataset to obtain a refined ML model (hereinafter, otherwise also referred to as ‘trained ML model’).

In a non-limiting implementation, to determine the top-ranked batch set, the server system may be configured to segregate the plurality of training data segments to obtain a first set of training batches (hereinafter, otherwise also referred to as a ‘plurality of batches’ or simply ‘batches’) based, at least in part, on a first segregation condition. Each training batch from the first set of training batches may include a subset of training samples. The server system may be configured to compute a similarity metric for each training batch from the first set of training batches based, at least in part, on a particular test sample from the test dataset. The similarity metric may indicate a count of training samples from the training batch that match the corresponding test sample. In an embodiment, the server system may compute the similarity metric using the one or more prediction models such as a second prediction model. Further, the server system may assign a rank to each training batch from the first set of training batches based, at least in part, on the similarity metric and the refining condition. The rank indicates an extent of a covariate shift among the plurality of batches of the training dataset. Furthermore, the server system may generate a subset of training batches (hereinafter, otherwise also referred to as ‘top-ranked batch set’) based, at least in part, on the rank of each training batch from the first set of training batches and a refining threshold. In a non-limiting implementation, the server system arranges the plurality of batches in a predefined order based on the rank associated with each batch of the plurality of batches. Then, the server system selects one or more batches from the plurality of batches based on the refining threshold to obtain the top-ranked batch set. Moreover, in an embodiment, to generate the refined training dataset, the server system may segregate the second subset of training data segments into a second set of training batches (hereinafter, otherwise also referred to as a ‘set of filtered batches’) based, at least in part, on a second segregation condition. The server system may extract or identify the set of relevant training batches from the second set of training batches based on comparing the second set of training batches with the subset of training batches. The refined training dataset may be generated based, at least in part, on the set of relevant training batches.

In a specific embodiment, the server system can receive a training request message for training the ML model from a managing entity. Then, the server system accesses the refined training dataset from the database. Thereafter, the server system trains the ML model to obtain a trained ML model based on the refined training dataset. Then, the server system transmits the trained ML model to the managing entity. The trained ML model is trained to generate a prediction related to a downstream task.

In other words, the methods and systems proposed in the present disclosure tackle the two primary causes of data drift, such as a covariate shift and a concept drift, in accordance with various embodiments of the present disclosure. In an embodiment, the method is performed by the server system. Further, the server system is configured to select the most relevant batches from the training data segments based on their relationship to the test samples in a test dataset. The server system is further configured to train the ML model using said batches for accurate inference.

In a non-limiting implementation, the method performed by the server system is based on two conjectures:
(i) If the reason for the decline in the accuracy of the ML model is that the training samples of the training dataset and the test samples of the test dataset reside in different regions of the data space, then it may be understood that the covariate drift has occurred. In such a scenario, it is logical to prioritize a training batch t whose features (Xₜ) are closest to those of the test batch (x_{*}).
(ii) If the reason for the accuracy drop is changes in the x→y relationship over time, then it may be understood that the concept drift has occurred. In such a scenario, it is prudent to exclude the training data segments that exhibit the concept drift relative to other training data segments. The server system may be configured to compute one or more gradient scores for each training data segment to decide which training data segments to retain and which to discard from the total number of the training data segments.

In various embodiments, to address the covariate shift and the concept drift, the one or more prediction models, such as a Multilayer Perceptron (MLP), a tree-based model, a Neural Network (NN)-based model, and the like, may be used without limiting the scope of the present disclosure. In a specific implementation, to address the covariate shift, a prediction model such as the second prediction model (e.g., a random forest-based model R) is trained meticulously on a set of labeled training batches such as {(X₁, y₁), . . . , (X_{T}, y_{T})}. This sophisticated technique partitions the training dataset, harnessing the strengths and advantages of the random forest-based model in organizing complex data distributions. During testing, the server system is configured to rank the training batches based on their similarity to the test sample by analyzing the leaf nodes in R where the test sample is mapped. More specifically, the training batches are ranked according to a concentration of training samples that fall within these leaf nodes, ensuring that the most pertinent data is utilized to refine model accuracy.

In another specific embodiment, the server system is configured to detect the concept drift in the training dataset. To detect the concept drift, the server system may segment the training dataset or the plurality of training samples in the training dataset into the plurality of data segments. Then, the server system may train another prediction model, such as the first prediction model, to monitor each training sample in the training dataset to identify potential changes in data patterns. It is noted that various drift detection methods can be employed, based on shifts in data distribution or model performance. As may be understood, when the concept drift is detected, a new training segment is created from the drift point and becomes the current segment. Then, the server system updates the second prediction model using selected training segments from the multiple training segments. If the concept drift is not detected, the training sample is added to the existing segment. In an embodiment, the server system is configured to perform two main operations for selecting data segments, such as: (i) discarding the training segments that no longer align with the current data pattern, and (ii) selecting a core subset of stable training segments for efficient model training. In some embodiments, the server system is configured to compute the gradient scores, such as a gradient-based disparity score and a gain score. It is noted that these scores are computationally efficient and independent of specific data characteristics, unlike traditional statistical distance measures that can struggle with high-dimensional data and scalability issues. It may also be noted that the method and the server system proposed in the present disclosure allow for adaptive handling of data drift without needing ground truth labels for retraining.

Various embodiments of the present disclosure offer multiple advantages and technical effects. For instance, the methods and the systems proposed in the present disclosure provide a solution to the problem of addressing data drift in AI or ML models to enhance model accuracy and robustness. This problem is solved by employing sophisticated data segmentation to select optimal data batches for training, ensuring that the models remain accurate over time. It is noted that the proposed approach is a scalable framework that combines data-centric approaches with adaptive management of both covariate and concept drift. Also, unlike conventional approaches, the proposed approach is a more data-driven approach by explicitly evaluating models on selected data segments, while minimizing computational costs.

More specifically, the proposed approach integrates data segmentation and drift management to enhance accuracy and efficiency in large-scale ML model deployments. By focusing on relevant data subsets, a reduction is observed in resource use, lowering costs and latency. The proposed approach also addresses both covariate shift and concept drift, maintaining model performance over time. Further, the proposed approach can be easily integrated with existing ML pipelines for smooth transitions and tracking. This approach enables organizations to maintain high-quality predictions and informed decisions in dynamic data environments.

In other words, the proposed approach introduces a robust framework that is scalable and efficient, combining the strengths of data-centric methods with multiple drift management techniques. In addition, the proposed approach provides an efficient data subset selection process that is adaptive, as it initially identifies core data segments while discarding those affected by the concept drift. Subsequently, it selects core data batches from these segments that are similar to the test samples, thereby mitigating the covariate shift. These steps reduce the amount of data required for training, leading to operational efficiencies. Extensive experiments on synthetic and real datasets may be conducted to demonstrate that the proposed approach provides better results while maintaining efficiency, which may be explained later in the present disclosure.

For example, hospital authorities at Hospital ‘A’ may have accumulated a substantial amount of patient historical data over the past 10 years. They may seek to use this data to predict whether patients are at risk for developing severe diseases in the future. Training a machine learning (ML) model on such a large dataset would require significant processing resources and time. To address this, the authorities can utilize features provided by the described server system, which refines the training dataset to improve the efficiency of ML model training. The server system initially divides the full training dataset into segments, such as on a monthly basis, with each segment representing one month's data. It then calculates a disparity score using a prediction model to identify and exclude irrelevant segments. The remaining intermediate segments undergo further filtering through the computation of a gain score to determine the most relevant data, resulting in a filtered set of segments. For example, the dataset could be reduced from 10 years to 5 years by retaining only months deemed relevant. Relevance is assessed by comparison to a test sample, which could be data from a recent month used for evaluating the ML model's predictions.

Simultaneously, the server system divides the original 10 years of monthly segmented data into smaller batches, such as weekly groups. Another prediction model ranks these batches based on similarity to the test sample, and a top-ranked group is selected. The filtered segments are then organized into batch sets and compared with the top-ranked set to produce a refined training dataset, which might be equivalent in size to 2 years, containing only the weeks classified as relevant from the entire 10-year period. Throughout this process, data affected by covariate shift and concept drift are excluded. This approach aims to mitigate data drift, potentially improving ML model accuracy and robustness, while also reducing the volume of data needed for training and promoting operational efficiency.

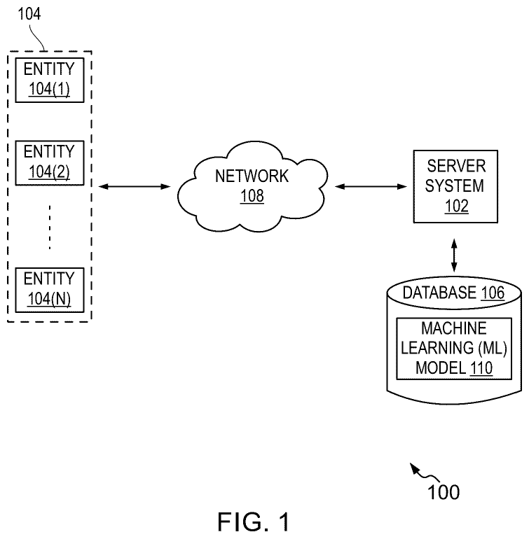

Various example embodiments of the present disclosure are described hereinafter with reference to FIG. 1 to FIG. 10.

FIG. 1 illustrates an example representation of an environment 100 related to at least some example embodiments of the present disclosure. Although the environment 100 is presented in one arrangement, other embodiments may include the parts of the environment 100 (or other parts) arranged otherwise depending on performing one or more operations, for example, generating a plurality of data segments from a training dataset, computing a set of gradient scores for each data segment, generating a set of filtered data segments based on a set of gradient scores, determining a top-ranked batch set, generating a refined training dataset, training a Machine Learning (ML) model using the refined training dataset to obtain a refined ML model, and the like.

The environment 100, generally includes a plurality of components, such as a server system 102, a plurality of entities 104(1), 104(2), . . . 104(N) (collectively referred to hereinafter as the ‘plurality of entities 104’ or simply, ‘entities 104’), a database 106, each coupled to, and in communication with (and/or with access to) a network 108. Herein, ‘N’ is a Natural number.

In an embodiment, the server system 102 may be used by a managing entity (not shown in FIG. 1) to train the ML model (e.g., the ML model 110) to generate predictions related to a task. Examples of the task can include anomaly detection, fraud detection, disease diagnosis, outlier detection, weather forecasting, speech recognition, image classification, email spam detection, risk management, charge-back decision-making systems, payment authorization systems, data analytics, credit card scoring systems, cross-border transaction management systems, consumer segmenting, etc., among other tasks.

In a non-limiting implementation, the managing entity may be any individual, representative of a person, an institution, an organization, a corporate entity, a non-profit organization, a financial institution, a bank, medical facilities (e.g., hospitals, laboratories, etc.), educational institutions, government agencies, telecom industries, or the like. In an example, the managing entity may be an administrator of the server system 102.

In one embodiment, the entities 104 may include individuals, objects, or concepts that may or may not interact with each other or are related or unrelated to each other. For example, the entity (e.g., the entity 104(1)) may include any individual, representative of a person, an object, a place or a location, an institution, an organization, a corporate entity, a non-profit organization, a financial institution, a bank, a cardholder, a merchant, medical facilities (e.g., hospitals, laboratories, etc.), educational institutions, government agencies, telecom industries, or the like.

In a specific embodiment, the entities (e.g., entities 104) correspond to individuals whose data is used for training the ML model 110. It is noted that the database 106 may be configured to store various AI or ML models such as the ML model 110. The data associated with the entities 104 can be referred to as an ‘entity-related dataset’, which may also be stored in the database 106. For instance, the entities 104 may be patients who are undergoing treatment for certain diseases. Data generated corresponding to such patients can be used to learn and understand the experience of the patients at a particular clinical center. Thus, such data is used to train AI or ML models to identify diseases and diagnoses. For example, classifying different diseases, such as cancer, using images, predicting the progression of pre-diabetes, predicting responses to depression treatment, etc. In another instance of a weather forecasting application, the entities 104 may correspond to individuals who provide information, such as location, date and time, preferences, alerts, activities, and the like. The information provided by such individuals can be used to generate predictions related to the weather that are more personalized and actionable. For example, preferences influence how the weather forecast data is presented to the entity (e.g., the entity 104(1)), while activity details can enable the application to highlight relevant weather conditions (e.g., rain or wind for outdoor plans) for the entity 104(1). In yet another instance of the payment industry, the entities 104 may be cardholders, merchants, consumers, issuers, acquirers, banks, third-party users, financial institutions, or the like. Data related to such individuals include historical financial transaction-related data, income-related data, expenditure-related data, and the like. Such data can be used to train AI or ML models to predict the income of an individual, predict financial frauds and risks, perform payment authorization operations, and the like.

Thus, it may be understood that the entity-related dataset can include information related to a plurality of entities (e.g., the entities 104). In an embodiment, the information can be different information specific to any field of operation, such as the payment industry, the medical industry, the transportation and logistics industry, and the like. Further, the various embodiments of the present disclosure apply to a variety of different fields of operation, and the same is covered within the scope of the present disclosure. The database 106 can also store other necessary machine instructions required for implementing the various functionalities of the server system 102 such as firmware data, operating system, and the like. In addition, the database 106 provides a storage location for data and/or metadata obtained from various operations performed by the server system 102.

In one embodiment, the database 106 may be incorporated in the server system 102 or maybe an individual entity connected to the server system 102 or maybe a database stored in cloud storage. In various non-limiting examples, the database 106 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the server system 102 with access to the database 106. In one implementation, the database 106 may be viewed, accessed, amended, updated, and/or deleted by an administrator (not shown) associated with the server system 102 through a Database Management System (DBMS) or Relational Database Management System (RDBMS) present within the database 106.

In some embodiments, the entities 104 may use their corresponding electronic devices (not shown in FIG. 1) to access a platform, such as a mobile application or a website associated with any third-party application, to perform an event. Examples of the event can be to purchase items made available by certain merchants, to request a doctor's appointment, and so on. In various non-limiting examples, the electronic devices may refer to any electronic devices, such as, but not limited to, Personal Computers (PCs), tablet devices, smart wearable devices, Personal Digital Assistants (PDAs), voice-activated assistants, Virtual Reality (VR) devices, smartphones, laptops, and the like.

In various embodiments, the network 108 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or entities illustrated in FIG. 1, or any combination thereof. Various entities in the environment 100 may connect to the network 108 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 108 may utilize a secure protocol (e.g., Hypertext Transfer Protocol (HTTP), Secure Socket Lock (SSL), and/or any other protocol, or set of protocols for communicating with the various entities depicted in FIG. 1.

In an embodiment, for training the ML model 110, the entity-related dataset can be split, and a training dataset may be extracted. The training dataset can be a portion of the entity-related dataset for a particular time period. For instance, if the entity-related dataset is information related to various operations performed by the entities 104 for a period of one year, the training dataset can be the information captured over 4 months (January to April of the year 2022). During a training phase of the ML model 110, the training dataset can be referred to as an input dataset for the ML model 110. Once trained, the ML model 110 may be tested and validated using datasets from different timelines, i.e., out of the one year's data, the remaining data (excluding the training dataset) can be further split into a validation dataset and a testing dataset. It is noted that the validation dataset can include information captured for another 4 months (May to August of the year 2022). Similarly, the testing dataset can include information captured for another 4 months (September to December of the year 2022). During the validation phase of the ML model 110, the validation dataset can be referred to as the input dataset, whereas during the testing phase, the input dataset to the ML model 110 changes to the testing dataset. Further, during deployment, the input dataset changes to a new dataset (i.e., a real-time dataset that is available during the deployment of the ML model 110).

It is noted that in the fast-changing world, due to several reasons, AI or ML models such as the ML model 110 can be perturbed by drift in the input dataset, deteriorating the model performance and accuracy. Reasons can be changes in data patterns or relationships, user behavior, market trends, the way the data is collected, seasonal trends, user preferences, external factors, and the like. Thus, it may be understood that the data drift occurs when the statistical properties of the input dataset change over time, and these properties no longer match with those of the training dataset, using which the ML model 110 is trained. In simple terms, the input dataset provided to the ML model 110 in the real world is different from the data that it is trained on. For example, if a model is developed using data from 2019 to forecast user preferences and is still in use in 2024 without any changes, it might not produce reliable predictions since user behavior, preferences, and outside variables would have changed. The predictive accuracy of the model has to be increased.

To eliminate such issues, over the years, several approaches have been developed. However, most of these existing conventional approaches have several drawbacks. One such drawback is that they lack mechanisms to validate whether the data preprocessing steps genuinely enhance model accuracy. In addition, most of the conventional approaches usually focus on either covariate or concept drift, often neglecting comprehensive solutions and discarding valuable historical data.

The above-mentioned technical problems, among other problems, are addressed by one or more embodiments implemented by the server system 102 and the methods thereof provided in the present disclosure. It is noted that the objective of the server system 102 is to identify segments of the training dataset that are affected by concept drift and covariate shift and discard them to obtain a refined training dataset. In an embodiment, another objective of the server system 102 is to re-train the model such as the ML model 110 with the refined training dataset to obtain a refined ML model (hereinafter, otherwise also referred to as a ‘trained ML model’ that has improved performance and accuracy in comparison to the ML model 110). Predictions generated related to a particular downstream task using the refined ML model are accurate in comparison to those generated by the ML model 110.

In a specific embodiment, the server system 102 is configured to access a plurality of data segments (hereinafter, otherwise also referred to as a ‘plurality of data segments’, ‘training data segments’ or ‘data segments’) from the database 106. Each data segment can include a subset of training samples associated with the training dataset. Each training sample may be associated with a training feature set. As may be understood, the training dataset may include a plurality of training samples corresponding to a plurality of entities such as the entities 104. In an embodiment, the server system 102 is configured to generate the data segments from the training dataset based on the training feature set. Then, the server system 102 is configured to compute a set of gradient scores for each data segment based on the training feature set associated with each training sample in each data segment and a test dataset. Herein, each gradient score may indicate a concept drift-based relevancy of a particular data segment among the plurality of data segments. In a non-limiting implementation, the gradient scores include a disparity score and a gain score, which can be computed using one or more prediction models such as a first prediction model. The computation of these gradient scores is explained later in the present disclosure.

The server system 102 is further configured to extract a first subset of training data segments (hereinafter, otherwise also referred to as an ‘intermediate set of data segments’) from the plurality of training data segments based, at least in part, on the disparity score. In other words, the server system 102 filters the plurality of data segments to obtain the set of filtered data segments based on the set of gradient scores and a set of gradient thresholds. In an embodiment, the first subset of training data segments is extracted using the one or more prediction models such as the first prediction model associated with the server system 102. This extraction process is also explained later in the present disclosure.

In a non-limiting implementation, the server system 102 is configured to extract a second subset of training data segments (hereinafter, otherwise also referred to as a ‘set of filtered data segments’) from the first subset of training data segments based, at least in part, on the gain score. In an embodiment, the server system 102 extracts the second subset of training data segments using the prediction models such as the first prediction model. This extraction process is also explained later in the present disclosure.

Furthermore, the server system 102 can determine a top-ranked batch set based on the plurality of data segments, the test dataset, and a refining condition. Herein, each data segment includes a subset of batches, and the top-ranked batch set includes one or more batches ranked based on the refining condition. Then, the server system 102 may be configured to generate a refined training dataset based, at least in part, on the second subset of training data segments and the refining condition. It is noted that the refined training dataset may include a set of relevant training batches extracted from the second subset of training data segments based on the refining condition. In other words, the server system 102 generates the refined training dataset based on the set of filtered data segments and the top-ranked batch set. Herein, the refining condition can be used for determining the top-ranked batch set. The process determining the top-ranked batch set and the refined training dataset is also explained later in the present disclosure. Thereafter, the server system 102 may train the ML model 110 based, at least in part, on the refined training dataset to obtain the refined ML model that can be used for generating accurate predictions for the downstream tasks.

As may be appreciated, various embodiments of the present disclosure offer multiple advantages and technical effects. For instance, the methods and the systems proposed in the present disclosure provide a solution to the problem of addressing data drift in AI or ML models to enhance model accuracy and robustness. This problem is solved by employing sophisticated data segmentation to select optimal data batches for training, ensuring that the models remain accurate over time. It is noted that the proposed approach is a scalable framework that combines data-centric approaches with adaptive management of both covariate and concept drift. Also, unlike conventional approaches, the proposed approach is a more data-driven approach by explicitly evaluating models on selected data segments, while minimizing computational costs.

More specifically, the proposed approach integrates data segmentation and drift management to enhance accuracy and efficiency in large-scale ML model deployments. By focusing on relevant data subsets, a reduction is observed in resource use, lowering costs and latency. The proposed approach also addresses both covariate shift and concept drift, maintaining model performance over time. Further, the proposed approach can be easily integrated with existing ML pipelines for smooth transitions and tracking. This approach enables organizations to maintain high-quality predictions and informed decisions in dynamic data environments.

In other words, the proposed approach introduces a robust framework that is scalable and efficient, combining the strengths of data-centric methods with multiple drift management techniques. In addition, the proposed approach provides an efficient data subset selection process that is adaptive, as it initially identifies core data segments while discarding those affected by the concept drift. Subsequently, it selects core data batches from these segments that are similar to the test samples, thereby mitigating the covariate shift. These steps reduce the amount of data required for training, leading to operational efficiencies. Extensive experiments on synthetic and real datasets may be conducted to demonstrate that the proposed approach provides better results while maintaining efficiency, which may be explained later in the present disclosure.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 108, which may be specifically configured, via executable instructions, to perform steps as described herein, and/or embodied in at least one non-transitory computer-readable media. More specifically, it should be noted that the number of components shown in FIG. 1 and described herein are only used for exemplary purposes and do not limit the scope of the approach proposed in the present disclosure.

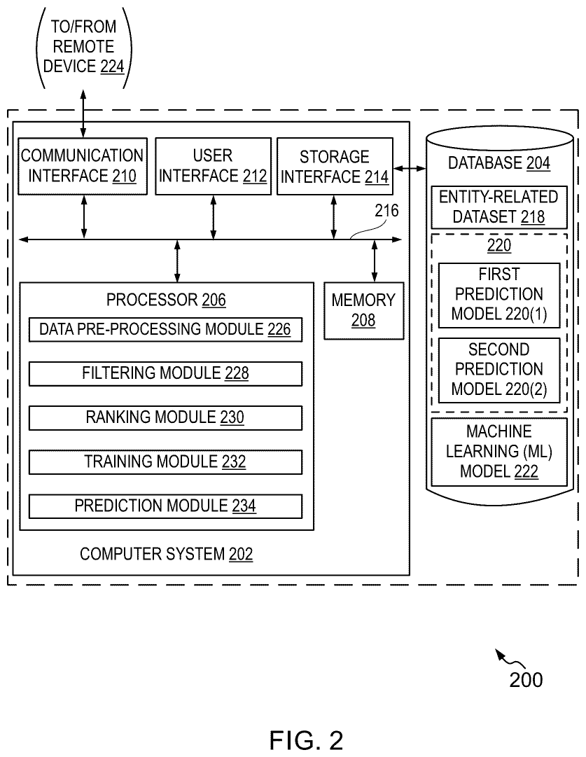

FIG. 2 illustrates a simplified block diagram of a server system 200, in accordance with an embodiment of the present disclosure. For example, the server system 200 is similar to the server system 102 as described in FIG. 1. In some embodiments, the server system 200 is embodied as a standalone physical server and/or has a cloud-based and/or SaaS-based (software as a service) architecture.

The server system 200 includes a computer system 202 and a database 204. The computer system 202 includes at least one processor such as a processor 206 for executing instructions, a memory 208, a communication interface 210, a user interface 212, and a storage interface 214. The one or more components of the computer system 202 communicate with each other via a bus 216. The components of the server system 200 provided herein may not be exhaustive, and the server system 200 may include more or fewer components than those depicted in FIG. 2. Further, two or more components depicted in FIG. 2 may be embodied in one single component, and/or one component may be configured using multiple sub-components to achieve the desired functionalities. The database 204 is an example of the database 106 of FIG. 1.

In some embodiments, the database 204 is integrated into the computer system 202. For example, the computer system 202 may include one or more hard disk drives as the database 204. In one non-limiting example, the database 204 is configured to store an entity-related dataset 218, one or more prediction models 220, including a first prediction model 220(1) and a second prediction model 220(2), an ML model 222, and the like. Herein, the entity-related dataset 218, the prediction models 220, and the ML model 222 are similar to the entity-related dataset, the prediction models, and the ML model 110, respectively, explained in the description of FIG. 1.

In a non-limiting example, the entity-related dataset 218 may include information related to the plurality of entities 104. The information can be historical information or information that is captured in real-time. The information may include personal information, historical information related to various operations performed by the entities 104, information related to the fraudulent experience of the entities 104, entity identity-related information, and the like. Examples of the operations that may be performed by the entities 104 can include purchasing a product, registering for a service, providing feedback to an offering through ratings, scores, commenting, and the like. Various examples of the historical information related to various operations performed by the entities 104 can include an operation type, a number of operations, a count of the entities 104 performing a particular operation, and the like. In an embodiment, the information can be represented in the form of data samples (otherwise, also referred to as ‘data points’) indicating different observations or instances for the above-mentioned information for the plurality of entities 104. Thus, the entity-related dataset 218 may include a plurality of data samples corresponding to the entities 104. In a non-limiting example, when the task that the ML model 222 needs to perform is weather forecasting, then the entity-related dataset 218 includes the data samples, with each data sample representing a record of weather conditions at a specific time and location. For instance, the data samples can be hourly or daily observations. In another example of a payment industry, for fraud detection, the entity-related dataset 218 can include data samples, with each data sample representing a financial transaction or account activity at a specific time instant.

In an embodiment, the type of model that may be chosen for the implementation of the prediction models 220 is dependent on the type of task the model is trained to perform. Various examples of the prediction models 220 can include a random forest-based model, a gradient boosting machine (GBM)-based model, an isolation forest-based model, an MLP, an NN-based model, and the like. In an embodiment, the ML model 222 can also be any of these models. It is noted that the prediction models 220 are trained and used to refine the entity-related dataset 218 used for training the ML model 222 to obtain the refined ML model (or the trained ML model). In a non-limiting example scenario, the prediction models 220 are pre-trained to generate predictions related to relevant events that are necessary to refine the entity-related dataset 218. Thus, in such an example scenario, the description of the training process of these models that can be used for training the prediction models 220 and the ML model 222 is not required.

Further, the computer system 202 may include one or more hard disk drives as the database 204. The user interface 212 is an interface such as a Human Machine Interface (HMI) or a software application, that allows entities such as an administrator, to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute computer-readable instructions for performing one or more operations for refining a training dataset for training the ML model 222 to obtain the trained ML model. Examples of the processor 206 include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), and the like.

In an embodiment, the memory 208 is capable of storing the computer-readable instructions. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the computer system 202 is capable of communicating with a remote device 224, such as any component connected to the network 108 (as shown in FIG. 1).

It is to be noted that the server system 200, as illustrated and hereinafter described, is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include a data pre-processing module 226, a filtering module 228, a ranking module 230, a training module 232, and a prediction module 234. It should be noted that components described herein can be configured in a variety of ways, including electronic circuitry, digital arithmetic, logic blocks, and memory systems in combination with software, firmware, and embedded technologies. Moreover, it should also be noted that these components may be communicably coupled with each other to exchange information with each other for performing the one or more operations facilitated by the server system 200.

In an embodiment, the data pre-processing module 226 includes suitable logic and/or interfaces for accessing the entity-related dataset 218 from the database 204. In a non-limiting implementation, the entity-related dataset 218 can include the information (as explained earlier) related to a plurality of entities (e.g., the entities 104). In another embodiment, the data pre-processing module 226 is configured to generate a feature set for each data sample in the entity-related dataset 218 based, at least in part, on the information related to the entities 104. The feature set can then be stored back in the database 204 and is accessible for future use.

As may be understood, the term ‘dataset’ refers to raw input data that may be used during different stages, such as training, testing, validating, or during the deployment of any AI or ML model. However, prior to using the dataset, it is prepared or made suitable for any of the above-mentioned stages by featurization or performing a feature generation operation on the dataset. Generally, the dataset includes multiple data points or data samples. As used herein, the terms ‘data point’ and ‘data sample’, may be used interchangeably and refer to a single instance or observation within the dataset.

In some embodiments, each data sample may represent a single user or individual. In some other embodiments, based on the nature of the dataset and the problem being addressed, a data sample may represent aggregated or summarized information about multiple users or individuals. However, it is noted that each data point or data sample represents a unique combination of features or attributes that describe some aspect of the objective of training the model. During featurization, in one embodiment, these features are extracted from the dataset for each data sample. In another embodiment, new features are generated for each data sample using the various data fields associated with each user or entity in the raw data. Both the extracted features and the newly generated features may correspond to insights, useful information, relevant patterns, and the like associated with the dataset.

Thus, it may be understood that the feature set may be obtained upon preprocessing the entity-related dataset 218 to improve the model's performance. In a non-limiting example, preprocessing the entity-related dataset 218 may include performing several operations on the entity-related dataset 218 to make the entity-related dataset 218 suitable for any stage of the model such as the prediction models 220. For instance, the operations may include removing noise, feature engineering (also referred to as featurization or feature generation), feature selection, data cleaning, handling missing values, normalizing or scaling data, analyzing characteristics of the data, converting the entity-related dataset 218 into a format that AI or ML models can process, and the like. Since these operations are well known in the art, the same have not been described herein for the sake of brevity.

For instance, when the entity-related dataset 218 is for weather forecasting, then various examples of the feature set can include current temperature, minimum temperature, maximum temperature, humidity, wind speed and direction, pressure, precipitation, cloud cover, weather conditions, such as clear, cloudy, rainy, etc., timestamp (i.e., time and date of observation), location (e.g., latitude, longitude, city name, etc.), and the like.

In another instance of fraud detection, various examples of the feature set that may be derived from the entity-related dataset 218 can include transaction amount, time and date of transaction, location of transaction (e.g., IP address, geographical location, etc.), transaction type, cardholder account details, frequency of transactions, merchant details, cardholder behavior patterns, and the like. Various other examples of the feature set can include multifarious data, such as social media data, Know Your Customer (KYC) data, payment data, trade data, employee data, Anti Money Laundering (AML) data, market abuse data, Foreign Account Tax Compliance Act (FATCA) data, fraudulent payment transaction data, and the like.

As may be understood, the entity-related dataset 218 can be split into a training dataset, a validation dataset, and a testing dataset, each dataset having a different timeline. Thus, the feature set obtained from the entity-related dataset 218 can also include a training feature set, a validation feature set, and a testing feature set derived from the training dataset, the validation dataset, and the testing dataset, respectively. As may be understood, the training dataset and the training feature set are used during a training phase of any AI or ML model, the validation dataset and validation feature set are used during the validation phase of the model, and the testing dataset and the testing feature set are used during the testing phase of the model. Once the model is trained, validated, and tested, upon deployment, its operation is tested in real-time on a real-time dataset and a real-time feature set.

In an embodiment, the filtering module 228 includes suitable logic and/or interfaces for accessing a training feature set corresponding to each training sample in the training dataset from the database 204. Herein, the training dataset may include a plurality of training samples corresponding to a plurality of entities such as the entities 104. The filtering module 228 is further configured to generate a plurality of training data segments (or data segments) from the training dataset based, at least in part, on the training feature set and store the data segments back into the database 204, which is accessible for future use.

In another embodiment, the filtering module 228 is configured to access the data segments from the database 204. Herein, each data segment can include a subset of training samples associated with the training dataset. Each training sample is associated with the training feature set. Thereafter, in an embodiment, the filtering module 228 computes a set of gradient scores for each data segment based on the training feature set associated with each training sample in each data segment and a test sample. In a non-limiting implementation, the gradient scores can include a disparity score and a gain score. Herein, each gradient score can indicate a concept drift-based relevancy of a particular data segment among the plurality of data segments. Moreover, the disparity score can indicate a dissimilarity extent between a data distribution of the corresponding data segment and the test dataset, contributing to the concept-drift based relevancy of the data segment. On the other hand, the gain score can indicate a similarity extent between the data distribution of the corresponding data segment and the test dataset, contributing to the concept-drift based relevancy of the data segment. As may be understood, the concept drift occurs when the relationship between input features and the target variable evolves over time, which alters underlying data patterns or data distribution. Thus, the concept drift-based relevancy in a particular data segment helps identify whether the corresponding data segment is associated with the concept drift or not in comparison to the test dataset. If available, then the gradient scores help identify the extent of the concept drift is present to discard the data segment with a certain amount (an unacceptable amount) of the concept drift from the training dataset to obtain the refined training dataset.

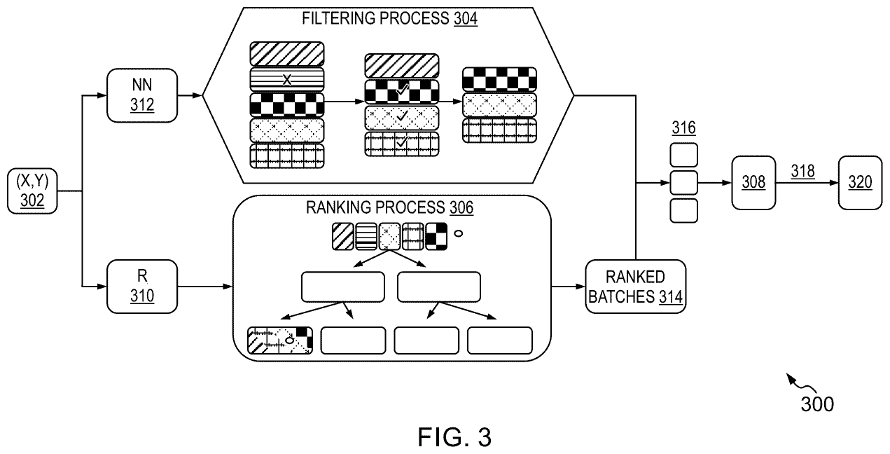

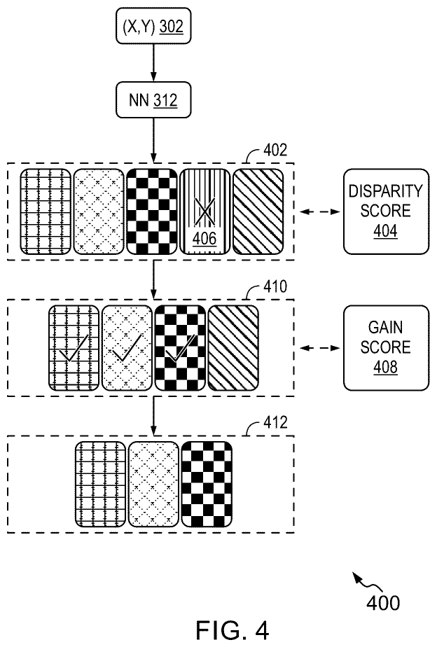

In an embodiment, the gradient scores may be computed using the prediction models 220 such as the first prediction model 220(1). Further, the filtering module 228 may be configured to extract the first subset of training data segments (hereinafter, otherwise also referred to as an ‘intermediate set of data segments’) from the plurality of training data segments based, at least in part, on the disparity score. In an embodiment, the filtering module 228 extracts the first subset of training data segments using the prediction models 220 such as the first prediction model 220(1). In another embodiment, using the first prediction model 220(1), the filtering module 228 may extract the second subset of training data segments (or the set of filtered data segments) from the first subset of training data segments based, at least in part, on the gain score. This process is explained later in the present disclosure with reference to FIG. 3 and FIG. 4.

In an embodiment, the training module 232 includes suitable logic and/or interfaces for training the prediction models 220 based on the training dataset. The process of training any AI or ML model is well-known to a person skilled in the art. However, for computing the gradient scores, gradients that may be obtained while training the first prediction model 220(1) are required. Thus, in an embodiment, the filtering module 228 utilizes the training module 232 for computing the disparity score. More specifically, the training module 232 is configured to train the first prediction model 220(1) by iteratively performing a set of operations for the plurality of data segments until predefined criteria are met. The first prediction model 220(1) is initialized using one or more model parameters. In a non-limiting implementation, the one or more model parameters may be initialized based at least on the type of the model chosen for the first prediction model 220(1). In general, the one or more model parameters may include, but are not limited to, coefficients or weights associated with each feature, bias terms, regularization parameters, and the like. In another embodiment, the one or more model parameters may also include hyperparameters, such as learning rate, epochs, kernel depth for SVM-based models, depth of trees for decision tree-based models, a number of layers, a number of neurons in a hidden layer of NN-based models, batch size, and the like.

In an embodiment, the set of operations includes computing a training gradient component for each training sample in each data segment based on the training feature set associated with the corresponding training sample. Then, the operations include computing a test gradient component for each test sample in the test dataset based on a test feature set associated with each test sample. The operations include computing the disparity score for each data segment based on the training gradient component of each training sample in the corresponding data segment, the test gradient component of each test sample, and a disparity score computation function (described later in the present disclosure with reference to Eqn. (6)). The operations also include optimizing the one or more model parameters based on backpropagation of the training gradient component.

In a non-limiting implementation, to compute the training gradient component for each training sample, the training module 232 generates an embedding for each training sample based on the training feature set associated with the corresponding training sample. Then, the training module 232, using the first prediction model 220(1), a probability score for each training sample based on the embedding associated with the corresponding training sample. Herein, the probability score indicates a likelihood that the training sample belongs to a particular class label. Then, the training module 232 generates a prediction for each training sample based on the probability score using the first prediction model 220(1). Herein, the prediction indicates a predicted class label of the training sample. Then, the training module 232 computes a loss for each training sample based on the predicted class label and a true label. Thereafter, the training module 232 computes the training gradient component for each training sample based on the loss of the corresponding training sample.

In another non-limiting implementation, to compute the test gradient component for each test sample, the training module 232 generates an embedding for each test sample based on the test feature set associated with the corresponding test sample. Then, the training module 232 generates, using the first prediction model 220(1), a probability score for each test sample based on the embedding associated with the corresponding test sample. Herein, the probability score indicates a likelihood that the corresponding test sample belongs to a particular class label. The training module 232 generates a prediction for each test sample based on the probability score using the first prediction model 220(1). Herein, the prediction indicates a predicted class label of the corresponding test sample. Then, the training module 232 computes a loss for each test sample based on the predicted class label and a true label. Thereafter, the training module 232 computes the test gradient component for each test sample based on the loss of the corresponding test sample. As mentioned earlier, these operations are performed iteratively until the predefined criteria are met. In an embodiment, the predefined criteria can correspond to a convergence of the first prediction model 220(1). In a non-limiting example, the convergence of the first prediction model 220(1) can correspond to a saturation of the loss. The loss can be saturated after a plurality of iterations of the set of operations is performed. Herein, the saturation may refer to a stage in the model training process after a certain number of iterations, where the loss becomes constant, i.e., the difference in the loss for one iteration and its subsequent iteration becomes the same or negligible. The loss of any model is associated with model performance, so the less the loss, the better the model performance. Hence, certain parameters associated with the model may be modified to reduce the loss value, thereby improving the model performance.

It is noted that, post computing the disparity score using the first prediction model 220(1), the filtering module 228 determines the intermediate set of data segments from the plurality of data segments based on the disparity score and the set of gradient thresholds. Herein, the set of gradient thresholds includes a specified threshold such as the disparity threshold, based on which the intermediate set of data segments is determined. More specifically, the filtering module 228 accesses the disparity score for each data segment of the plurality of data segments from the database 204. Then, the filtering module 228 selects one or more data segments from the plurality of data segments to obtain the intermediate set of data segments based on the disparity score being at least equal to the disparity threshold. For instance, if the disparity score ranges between 0 to 1, and the disparity threshold is 0.5, then all the data segments having the disparity score greater than or equal to 0.5 are selected. These are the data segments that are the most relevant ones to the test dataset in terms of their data distribution indicating a relationship between input features and target variables. All the data segments having the disparity score less than 0.5 are discarded, as these data segments are considered to be the most irrelevant to the test dataset in terms of their data distribution. Thus, it is noted that by applying the disparity score to the data segments of the training dataset, the concept drift is eliminated from the training dataset.

In a specific embodiment, the filtering module 228 utilizes the training module 232 for computing the gain score. More specifically, the training module 232 is configured to train the first prediction model 220(1) by iteratively performing a set of operations for each epoch of the intermediate set of data segments until the predefined criteria are met. The first prediction model is initialized using the one or more model parameters. Herein, the model parameters may be similar to the model parameters initialized for the first prediction model 220(1) while training the first prediction model 220(1) for obtaining the disparity score. The set of operations includes computing a training gradient component for each training sample in each data segment of the intermediate set of data segments based on the training feature set associated with the corresponding training sample. Then, the operations include computing a test gradient component for each test sample in the test dataset based on the test feature set associated with each test sample. Then, the operations include computing the gain score for each data segment of the intermediate set of data segments based on the training gradient component of each training sample in the corresponding data segment, the test gradient component of each test sample, and a gain score computation function (described later in the present disclosure with reference to Eqn. (7)). It is noted that these operations appear to be similar to the operations performed while training the first prediction model 220(1) for generating the disparity score. However, the difference is that the data for which the disparity score is generated is different from the data for which the gain score is generated. Also, the computation functions used for computing each score are different.

It is noted that, post computing the gain score using the first prediction model 220(1), the filtering module 228 selects one or more data segments from the intermediate set of data segments to obtain the set of filtered data segments based on the gain score being at least equal to a gain threshold. The second subset of training data segments (or the set of filtered data segments), along with the training dataset, may be provided to the ranking module 230 for further processing.

In an embodiment, the ranking module 230 includes suitable logic and/or interfaces for determining the top-ranked batch set based on the plurality of data segments, the test dataset, and the refining condition. Each data segment includes a subset of batches. The top-ranked batch set includes one or more batches ranked based on the refining condition. Then, the ranking module 230 generates the refined training dataset based, at least in part, on the second subset of training data segments and the refining condition. The refined training dataset may include the set of relevant training batches extracted from the second subset of training data segments based on the refining condition. In a non-limiting implementation, the refining condition refers to a condition based on which the training batches are selected from the second subset of training data segments to obtain the refined training dataset. In an embodiment, the condition includes a requirement to identify the training samples that closely match a particular test sample in the test dataset.

For example, out of 10 training batches from the training dataset, each training batch can include 20 training samples. Some of the training samples from each training batch can match a test sample in the test dataset, including 20 test samples. For example, 5 training samples from a particular training batch can match the test sample, 10 from another batch can match the test sample, 15 from another batch can match the test sample, and so on. Thus, based on the number of training samples from each training batch matching the test sample, the training batches are ranked. The higher the number of matched training samples in a particular training batch with the test sample, the higher the rank value assigned to the corresponding training batch. For instance, the training batch with 15 training samples matching the test sample is assigned a 1^{st} rank (highest rank), followed by the training batch with 10 training samples matching the test sample is assigned a 2^{nd} rank, and so on.

In other words, the ranking module 230 generates the refined training dataset based on the set of filtered data segments and the top-ranked batch set. As may be understood, the top-ranked batch set is determined based on the refining condition. In a non-limiting implementation, the ranking module 230 arranges the plurality of batches in a predefined order based on the rank associated with each batch of the plurality of batches. In an example, the predefined order can be an ascending order or a descending order. For instance, the batches can be arranged in an order from 1^{st} rank, 2^{nd} rank, and so on. Then, the ranking module 230 selects one or more batches from the plurality of batches based on the refining threshold to obtain the top-ranked batch set. Herein, the refining threshold can be defined by the admin of the server system 200. For instance, the refining threshold can be to select the top 30% of the batches from the training dataset to ensure that the appropriate accuracy and performance of the model (e.g., the ML model 222) that may be trained using the refined training dataset. More specifically, for determining the top-ranked batch, the ranking module 230 may be configured to segregate the plurality of training data segments to obtain a first set of training batches (hereinafter, otherwise also referred to as a ‘plurality of batches’ or simply ‘batches’) based, at least in part, on a first segregation condition. Each training batch may include a subset of training samples, with the size of the batch being smaller than the size of the data segment in terms of the count of the training samples in the batch and the data segment. The plurality of batches includes the subset of batches. In an example implementation, the first segregation condition can include randomly selecting a predefined count of training samples from the training dataset to form a training batch (or a batch). In an embodiment, the first segregation condition may be dependent on the type of model used for ranking the training batches.

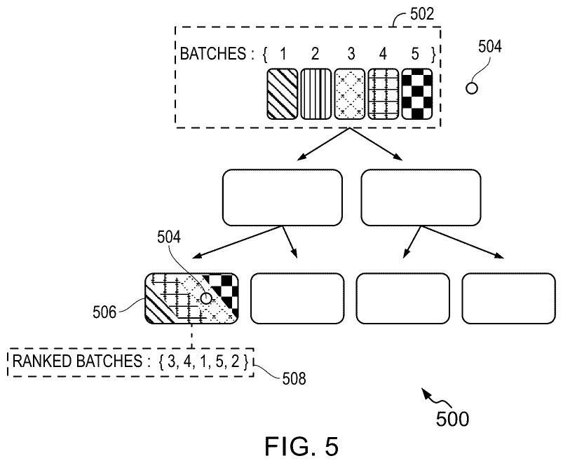

In another embodiment, the ranking module 230 is further configured to compute a similarity metric for each training batch from the first set of training batches based, at least in part, on a particular test sample from the test dataset. The similarity metric may indicate a count of training samples from the corresponding training batch that match the corresponding test sample. Further, the ranking module 230 may assign a rank to each training batch from the first set of training batches based, at least in part, on the similarity metric and the refining condition. The rank indicates an extent of a covariate shift among the plurality of batches of the training dataset. As may be understood, the covariate shift occurs when input features change between the training dataset and the test dataset, while their relationship with the target variable remains the same. Thus, the top-ranked batch set can include batches having minimal covariate shift among their training samples in comparison to other batches. Further, the ranking module 230 may generate a subset of training batches (or the top-ranked batch set) based on the rank of each training batch from the first set of training batches and a refining threshold. More specifically, the subset of training batches can correspond to training batches from the first set of training batches with a rank greater than or equal to the refining threshold. All the training batches having a rank less than the refining threshold are discarded from the first set of training batches. Due to this process, the covariate shift from the training dataset may be eliminated. The process of ranking the training batches is further elaborated later in the present disclosure with reference to FIG. 3 and FIG. 5.

In another embodiment, to generate the refined training dataset, the ranking module 230 may segregate the second subset of training data segments into a second set of training batches (hereinafter, otherwise also referred to as a ‘set of filtered batches’) based on a second segregation condition. In an example, the second segregation condition can include randomly selecting a predefined count of training samples from the second subset of training data segments to form a training batch. Further, the ranking module 230 may extract or identify the set of relevant training batches from the second set of training batches based on comparing the second set of training batches with the subset of training batches. Upon extracting the set of relevant training batches, the refined training dataset is generated. In other words, the ranking module 230 segregates the set of filtered data segments into the set of filtered batches based on the second segregation condition. Then, the ranking module 230 identifies the set of relevant batches from the top-ranked batches to obtain the refined training dataset based on the comparison of the top-ranked batch set with the filtered set of batches. In an embodiment, the various operations performed by the ranking module 230 are performed using the second prediction model 220(2). More specifically, the ranking module 230 may generate the similarity metric using the second prediction model 220(2). The process of generating the refined training dataset is explained using various examples and experiments later in the present disclosure. Further, the training module 232 may train the ML model 222 based, at least in part, on the refined training dataset to obtain a refined ML model.

In an embodiment, the prediction module 234 includes suitable logic and/or interfaces for receiving a prediction request for a downstream task from a managing entity. The prediction module 234 may generate a prediction based, at least in part, on the refined training dataset. In a non-limiting implementation, the prediction module 234 may generate the prediction using the refined ML model that is obtained by re-training the ML model 222 based on the refined training dataset.

In another embodiment, the prediction module 234 receives a training request message for training the ML model 222 from the managing entity. Then, the prediction module 234 accesses the refined training dataset from the database 204. Thereafter, the prediction module 234 trains the ML model 222 to obtain the trained ML model based on the refined training dataset. Then, the prediction module 234 transmits the trained ML model to the managing entity. It is noted that the trained ML model is trained to generate a prediction related to the downstream task.

FIG. 3 illustrates a schematic representation of an architecture 300 for refining a training dataset such as a training dataset 302, for training an ML model such as the ML model 222, in accordance with an embodiment of the present disclosure. Herein, the training dataset 302 is an example of the training dataset extracted from the entity-related dataset 218, explained with reference to FIG. 2. In a non-limiting example implementation, in supervised learning tasks, where the feature set ‘X’ is used to predict labels ‘y’, data drift is commonly caused by two factors, such as the covariate shift and the concept drift. As may be understood, the covariate shift occurs when the distribution of the feature set ‘X’ changes, such as when new types of incidents with previously unseen feature values arise. The concept drift happens when the underlying relationship between the feature set ‘X’ and the labels ‘y’ shifts, for example, due to changes in a system and its dependencies, leading to different causal relationships between systems and components. The training dataset 302 is shown in FIG. 3 as (X, Y), with ‘X’ indicating the feature set (or the training feature set) and ‘Y’ indicating the labels ‘y’.

The proposed approach employs two strategies for refining the training dataset 302, such as a filtering process (see, 304) implemented by the filtering module 228 of the server system 200 and a ranking process (see, 306) implemented by the ranking module 230 of the server system 200. In an embodiment, these processes may be parallelly implemented and the results of each process may be combined to generate a refined training dataset 308 from the training dataset 302. In an alternative embodiment, these processes may be performed sequentially, and the results of each process may be combined to generate the refined training dataset 308. For instance, the ranking process 306 may be implemented before the implementation of the filtering process 304 or vice versa.

In an embodiment, for the implementation of the ranking process, the second prediction model 220(2) used by the ranking module 230 can be a Random Forest. This model may be represented in FIG. 3 as model R (see, 310). This model may be used to partition and rank batches of the training dataset based on a specified batch size. It addresses the covariate shift. The training module 232 may be configured to train the second prediction model 220(2). In a non-limiting implementation, the ranking module 230 may implement an Algorithm 1, representing the ranking process 306 using the second prediction model 220(2), which is as follows:

Algorithm 1: Covariate Shift Scoring

Input: Training data batches {(X₁, y₁), . . ., (X_{T}, y_{T})}
Output: Stored values S [k] [t] for each tree T
Train model R on entire data (X₁, y₁), . . ., (X_{T}, y_{T});
for each tree Tᵢ ∈ R, perform
Store Sⁱ[kⁱ][t] = Σ_{(t≠t′)} {1 if N[kⁱ][t] > N[kⁱ][t′]};

As may be understood, the ranking process 306 utilizes the Algorithm 1 as described above. It is noted that the Algorithm 1 provides a process for detecting the covariate shift by examining how sample distributions vary across different batches through the lens of a trained model's decision trees. Initially, the entire training dataset such as the training dataset 302 is utilized by the training module 232 to train the model R 310. Then, for each individual decision tree Tᵢ within the model R 310, as per the Algorithm 1, the ranking module 230 computes the similarity metric such as a score S[k][t] for every batch t across each leaf node k. This score quantifies how many other batches within the same leaf node contain fewer samples N[k][t] compared to the batch t under consideration. By evaluating these scores, the ranking module 230 can detect shifts in feature distributions among different batches, which may signal potential covariate shifts. The ranking process 306 is further elaborated later in the present disclosure with reference to FIG. 5.

In another embodiment, for the implementation of the filtering process 304, the first prediction model 220(1) used by the filtering module 228 can be a simple Neural Network (NN) classifier trained using a cross-entropy loss. This model may be shown in FIG. 3 as model NN (see, 312). This model may be used to deal with the concept drift. The filtering process 304 discards the segments from the training dataset 302 based on the gain and disparity scores. The training module 232 may be configured to train the first prediction model 220(1). Further, only relevant batches from the remaining segments are selected, leading to a reduction in data used for training. In a non-limiting implementation, the filtering module 228 may implement an Algorithm 2, representing the filtering process 304 using the first prediction model 220(1), which is as follows:

Algorithm 2: Data Selection Algorithm

```
Input: Previous data segments Dₚᵣₑᵥ = {d₁, ... , d_{N-1}}, current segment d_{T}_{_{N}}, validation set
d_{V}_{_{N}}, loss function L, learning rate η, maximum epochs T, disparity threshold T_{d}, batch size
B, number of estimators nₑₛₜᵢₘₐₜₒᵣₛ, and maximum depth dₘₐₓ
Output: Final model parameters θ_{T},
for epoch t in [1, . . . , T], perform:
  (i) Initialize training subset S = ∅;
      ${g}_{V} = \frac{1}{\vert {d}_{{V}_{N}} \vert} {\sum }_{j = 1}^{\vert {d}_{{V}_{N}} \vert} {g}_{j} ;$
      for segment d in Dₚᵣₑᵥ perform:
      ${g}_{d} = \frac{1}{\vert d \vert} {\sum }_{k = 1}^{\vert d \vert} {g}_{k} ;$
      G_{d} = g_{d} · g_{V};
      D_{d} = || g_{d} − g_{V} ||;
      if G_{d} > 0 and D_{d} < T_{d} then
      S = S ∪ d; else
      S = S ∪ d_{T}_{_{N}};
  (ii) Initialize best batches B_{best} = ∅;
      for each sample v in d_{V}_{_{N}} perform:
      Get the rankings of the batches based on the mapped leaf of v in rf;
      for each batch in the rankings perform:
      if batch is in S then
      B_{best} = B_{best} ∪ batch;
  (iii)  $Update {θ}_{t} = {θ}_{t - 1} - η \frac{1}{{B}_{b e s t}} {\sum }_{e ∈ {B}_{b e s t}} {∇}_{θ} L ( e )$
  (iv) Return final model parameters θ_{T}
```

As may be understood, the filtering process 304 utilizes the Algorithm 2 as described above. It is noted that the Algorithm 2 outlines the procedure for selecting data segments to optimize model training. The process starts by initializing the model parameters and proceeds through a series of epochs. For each epoch, as per the Algorithm 2, the training module 232 initializes an empty training subset S. It then calculates the average gradient over the validation set d_{V}_{_{N}}. Next, the training module 232 iterates the steps of the Algorithm 2 over previous data segments to compute their gradient averages and evaluates their gain and disparity scores. Data segments with a positive gain score and a disparity score below a specified threshold are added to the training subset S. The current training data dry is always included in S to ensure recent data is used in training. Additionally, as per the Algorithm 2, the training module 232 initializes an empty set for the best batches B_{best}. For each sample v in the validation set d_{V}_{_{N}}, the filtering module 228 retrieves the rankings of the batches received from the ranking module 230 that implemented the Algorithm 1 based on the mapped leaf of v in the random forest (rf)-based model. The training module 232 then iterates the steps of the Algorithm 2 through these ranked batches (see, 314) and adds them to B_{best} (see, 316) if they are part of the selected segments S, breaking the loop once a suitable batch is found. This ensures that the best batches from the validation set, which are also part of the selected training segments, are prioritized. The model parameters are updated using the learning rate n and the computed gradients from the best batches B_{best}. This process is repeated for T epochs. Finally, the training module 232 returns the updated model parameters θ_{T}. Upon obtaining the best batches, the filtering module 288 generates the refined training dataset 308, which can be used for re-training (see, 318) the ML model 222 for obtaining a refined ML model 320. The refined ML model 320 can then be used for generating accurate predictions for a task upon receiving a prediction request from a user such as the managing entity.

FIG. 4 illustrates a schematic representation of a process 400 of filtering data segments such as training data segments 402 extracted from the training dataset such as the training dataset 302, in accordance with an embodiment of the present disclosure. In a non-limiting implementation, the process 400 is an example of the filtering process explained with reference to FIG. 3. In another implementation, the process 400 may be a further elaboration of the filtering process explained with reference to FIG. 3. As may be understood, the term ‘concept drift’ refers to a phenomenon where the relationship between the input features such as the feature set (e.g., ‘X’) and the target variable such as ‘y’ changes over time. This change affects the conditional distribution P (y|X). This may mean that the way the output is generated from the feature set evolves. In a non-limiting example, for the feature set ‘X’ and the target variable ‘y’, the concept drift is defined as follows:

$${P}_{Train} ( y \vert X ) \neq {P}_{Test} ( y \vert X ) \qquad Eqn . ( 1 )$$

To tackle the concept drift, the server system 200 is configured to perform two key tasks: (1) removing data segments that show concept drift compared to the current segment, and (2) selecting a core set of stable data segments to train the ML model 222 efficiently while maintaining accuracy. The filtering module 228 computes the disparity and gains scores based on gradient values on training and validation sets, ensuring minimal computational cost. Based on these scores, the stable data segments are selected.

In an embodiment, for the gradient computation, the last layer of the neural network, which is used for the implementation of the first prediction model 220(1), calculates the logits for each class. Suppose

$${X}_{i}^{′} ∈ {ℝ}^{{d}^{′}}$$

be the embedding feature of the ith input data Xᵢ with a hidden layer dimension of d′. Further, suppose zᵢ∈ [symbol] ^{c} be the logit outputs computed by

$${z}_{i} = w \cdot {X}_{i}^{′} + b$$

using the last layer weights w∈ [symbol] ^{d′×c} and bias b∈ [symbol] ^{c}. In a non-limiting example, to convert the logit zᵢ into a probability vector ŷᵢ, a softmax function is used as follows:

$${\hat{y}}_{i} = softmax ( {z}_{i} ) = \frac{{e}^{{z}_{ij}}}{{\sum }_{j = 1}^{c} {e}^{{z}_{ij}}} \qquad Eqn . ( 2 )$$

The model output can also be re-written as ŷᵢ which is a function of the model parameters θ and the input data Xᵢ. In a non-limiting implementation, it may be represented as follows:

$${\hat{y}}_{i} = {f}_{θ} ( {X}_{i} ) \qquad Eqn . ( 3 )$$

Further, in another example, given the model output ŷᵢ and the true label yᵢ, the cross-entropy loss between them can be computed as follows:

$${L}_{i} = L ( {y}_{i} , {\hat{y}}_{i} ) = - {\sum }_{j = 1}^{c} {y}_{ij} log ( {\hat{y}}_{ij} ) \qquad Eqn . ( 4 )$$

In an embodiment, the last layer gradient approximation is given as g=(∇_{b}L, ∇_{w}L), where gradients of the front layers are not used. Using the chain rule, the gradient of the i^{th} sample can be computed as follows:

$$g = ( {∇}_{b} L , {∇}_{w} L ) = ( {\hat{y}}_{i} - {y}_{i} , ( {\hat{y}}_{i} - {y}_{i} ) \cdot {X}_{i}^{′} ) \qquad Eqn . ( 5 )$$

Further, in an embodiment, the filtering module 228 can compute the disparity score (see, 404) based on the computed gradients. The disparity score D, is a measurement of dissimilarity between two data distributions. It detects segments exhibiting concept drift (see, 406). The concept drift is characterized by a change in the posterior distribution P(y|X) while the data distribution P(X) remains constant. Essentially, it reflects variations in the predicted labels y for the same input data. To quantify this change, the measure [symbol] [∥yₜ−yᵥ∥] can be used, which represents the expected label difference between a training subset and a validation set (or a test dataset), where yₜ and yᵥ denote the true labels from the training and validation sets, respectively. Direct computation of this measure is computationally expensive as it requires identifying similar samples across the training and validation sets and comparing their label differences. To overcome this, a gradient-based score can be generated, which is an efficient approximation. In an example, the disparity score D of a training subset T with respect to a validation set (or a test dataset) V is defined by the disparity score computation function as follows:

$$D ( T , V ) = ‖ \frac{1}{\vert T \vert} {\sum }_{t = 1}^{\vert T \vert} {g}_{t} - \frac{1}{\vert V \vert} {\sum }_{v = 1}^{\vert V \vert} {g}_{v} ‖ = ‖ 𝔼 [ {g}_{t} ] - 𝔼 [ {g}_{v} ] ‖ \qquad Eqn . ( 6 )$$

Here, |V| denotes the size of the validation set. Also, the D score measures the L2-norm distance between two gradient vectors. Upon computing the disparity score, the filtering module 228 may discard the segments having the disparity score below the specified threshold.

In another embodiment, the filtering module 228 can further compute the gain score (see, 408) for the remaining segments (see, 410). It is noted that to compute the gain score, historical data for both the training and validation (or test) phases are considered. It is noted that selecting a subset where the inner product of the average gradients between the subset and the validation set (known as the gain) is positive and can lower the model's validation loss during training. Essentially, gradient vectors represent the direction and size of updates in gradient descent, and aligning these gradients between the training and validation sets helps improve model performance. In an example, the gain score G for a training subset T with respect to a validation set V is defined by the gain score computation function as follows:

$$G ( T , V ) = \frac{1}{\vert T \vert} {\sum }_{t = 1}^{\vert T \vert} {g}_{t} - \frac{1}{\vert V \vert} {\sum }_{v = 1}^{\vert V \vert} {g}_{v} = 𝔼 [ {g}_{t} ] \cdot 𝔼 [ {g}_{v} ] \qquad Eqn . ( 7 )$$

Here, ‘·’ represents the dot product of the gradient vectors. Upon computing the gain score, the filtering module 228 may retain the segments (see, 412) having the gain score that is positive.

FIG. 5 illustrates a schematic representation of a process 500 of determining a covariate shift ranking of a set of training batches such as batches {1, 2, 3, 4, 5} (see, 502), in accordance with an embodiment of the present disclosure. In a non-limiting implementation, the process 500 is an example of the ranking process 306 (as shown in FIG. 3) explained with reference to FIG. 3. In another implementation, the process 500 may be a further elaboration of the ranking process 306 explained with reference to FIG. 3. As may be understood, the covariate shift is a type of data drift where the distribution of the input features (covariates) such as the feature set (e.g., ‘X’) changes between the training dataset and the test dataset, but the relationship between the feature set ‘X’, and the target variable such as ‘y’ (i.e., a conditional distribution P (y|X)) remains the same. In a non-limiting example, for the feature set ‘X’, the covariate shift can be defined as follows:

$${P}_{Train} ( X ) \neq {P}_{Test} ( X ) \qquad Eqn . ( 8 )$$

In an embodiment, to prioritize the training data segments based on the covariate shift, the proximity of the training data segments to test points such as a test point 504 in the data space, is determined. Although ranking training batches by their average Euclidean distance from the test point can be used, however, this method has limitations. Euclidean distance computation becomes expensive with larger batches, is prone to outliers, and struggles with high-dimensional data. Thus, the second prediction model 220(2) such as a decision tree or a random forest-based model, can be used for ranking batches. This approach scales well, is more robust to outliers, and handles high-dimensional data more effectively, making it a practical choice for complex datasets.

More specifically, in an embodiment, the decision trees classify data by partitioning it at feature thresholds that optimize prediction accuracy, grouping similar samples into the same leaf nodes such as a leaf node 506. When a new sample is tested, it is routed to a leaf node such as the leaf node 506, and its label is predicted based on the majority label within that node. This mechanism may be used to evaluate training batches for the covariate shift, prioritizing those that are closer to the test sample. The ranked batches are represented in FIG. 5 as batches {3, 4, 1, 5, 2} (see, 508).

For example, if {(X₁, y₁), . . . , (X_{T}, y_{T})} denote training batches, a decision tree may be generated based on these batches. Once the decision tree is constructed on these batches, suppose N[k][t] indicate the number of samples from batch t that fall into a leaf node k. Further, for a test point (e.g., the test point 504) that is assigned to a leaf node k_{*}, a covariate shift ranking such as Rank_{cov_shift} of the training batches can be calculated. In an example, this ranking is computed by ordering N[k_{*}][t] starting from the lowest covariate shift to the highest, as shown:

$${Rank}_{cov \_ shift} = arg sort \{ N [ {k}_{*} ] [ 1 ] , … , N [ {k}_{*} ] [ T ] \} \qquad Eqn . ( 9 )$$

Further, as the random forest-based model is capable of modeling high-dimensional data, this approach is extended to the random forests to detect and eliminate the concept drift for better performance of the ML model 222, as explained earlier with reference to FIG. 4.

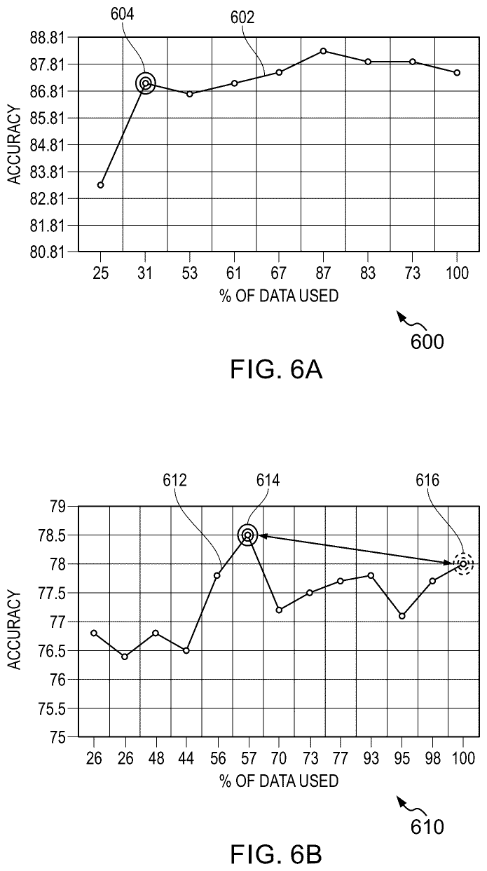

FIG. 6A illustrates a graphical representation 600 depicting an effect of varying percentages of data used for training on an accuracy of the ML model such as the ML model 222, for an example training dataset, in accordance with an embodiment of the present disclosure. FIG. 6B illustrates a graphical representation 610 depicting an effect of varying percentages of data used for training on the accuracy of the ML model 222 for another example training dataset, in accordance with an embodiment of the present disclosure. As may be understood, the server system 200 is configured to generate the refined training dataset from the training dataset such that the accuracy of the ML model 222 can be improved. Herein, the refined training dataset includes training samples that are relevant and sufficient for training the ML model 222. In an embodiment, the percentage of training samples in the refined training dataset can be less than the percentage of training samples in the training dataset. Thus, it may be understood that as the percentage of training samples within a dataset changes, the accuracy of the model that uses this dataset also changes. It is noted that several experiments are conducted to analyze the effect on the accuracy of the model such as the ML model 222, due to varying percentages of data in a dataset used for training the ML model 222.

In a non-limiting implementation, the datasets considered for one of the experiments can be a usenet2 dataset and a weather dataset. The graphical representation 600 is for the example training dataset, including the usenet2 dataset, and the graphical representation 610 is for the another example training dataset, including the weather dataset. It is noted that these are public datasets that are publicly available for conducting experiments for different applications. As per the experiment, the effect of varying the proportion of data used for training the ML model 222 on the model's accuracy is analyzed. The goal is to determine the minimal amount of data required to achieve optimal performance.

Referring to FIG. 6A, a curve 602 indicates the relationship of the varying data such as the usenet2 dataset, on the accuracy of the ML model 222. A significant increase in the accuracy when utilizing 32% of the data is observed, reaching approximately 87% (see, 604). This initial boost suggests that even a smaller subset of the data can capture the essential patterns necessary for effective model training. As more data is used, the accuracy is observed to gradually increase and then stabilize, indicating that the additional data provides diminishing returns. The highest accuracy is observed by around 87% data utilization, after which the performance slightly decreases, reinforcing the notion that more data does not always equate to better accuracy and might even introduce noise or redundancy.

Referring to FIG. 6B, a curve 612 depicts the relationship of the varying data such as the weather dataset, on the accuracy of the ML model 222. Highlighted points such as points 614 and 616 on the curve 612, mark a significant insight into data efficiency. It may be observed that, at 58% data utilization, the ML model 222 reaches its peak accuracy of 78.5% (see, 614), which is higher than the accuracy obtained using the entire dataset. This indicates an optimal subset of data that maximizes the model's performance while minimizing the computational resources required. Notably, the accuracy drops when nearing 100% data utilization, which underscores the importance of strategic data selection over sheer volume. The pattern observed here suggests that careful curation of training data segments, focusing on the most relevant subsets, can lead to superior model performance and operational efficiency. Therefore, the experiment conducted on both the usenet2 and weather datasets can be referred to as an ablation study. It reveals that optimal performance can be achieved with significantly less data than the full dataset. By focusing on the most relevant data, model accuracy can be maintained or even improved, making the training process more resource-efficient and effective. These findings highlight the importance of strategic data selection in developing robust and scalable ML models.

It is noted that the result of the ablation study experiment by just implementing the filtering process (i.e., using Algorithm 2), followed by implementing both the filtering process and the ranking process (i.e., using Algorithm 1), and the training time across the models is shown in Table 1. It is noted that the results shown in Table 1 are approximate in nature and may vary by a factor of +5% due to various experimental conditions.

TABLE 1
Ablation study results

| | RF | Model | Total | Only | Alg. |
|---|---|---|---|---|---|
| | train | train | train | Alg. 1 | 1 and 2 |
| Dataset | time | time | time | Accuracy | |
| SEA | 1.213 | 0.244 | 1.457 | .784 | .899 |
| Random RBF | 1.360 | 2.022 | 3.382 | .704 | .839 |
| Sine | 1.238 | 3.131 | 4.369 | .274 | .955 |
| Hyperplane | 1.252 | 1.429 | 2.681 | .733 | .924 |
| Covcon | 0.710 | 0.303 | 1.441 | .421 | .988 |
| Covcon_5M | 707 | 24 | 731 | .709 | .968 |
| Electricity | 1.437 | 1.476 | 2.528 | .718 | .833 |
| Weather | 0.590 | 0.712 | 1.302 | .775 | .778 |
| Spam | 0.276 | 0.614 | 0.890 | .883 | .992 |
| Usenet1 | 0.035 | 0.084 | 0.119 | .808 | .904 |
| Usenet2 | 0.037 | 0.056 | 0.147 | .771 | .879 |
| Covertype | 46 | 74 | 120 | .647 | .689 |

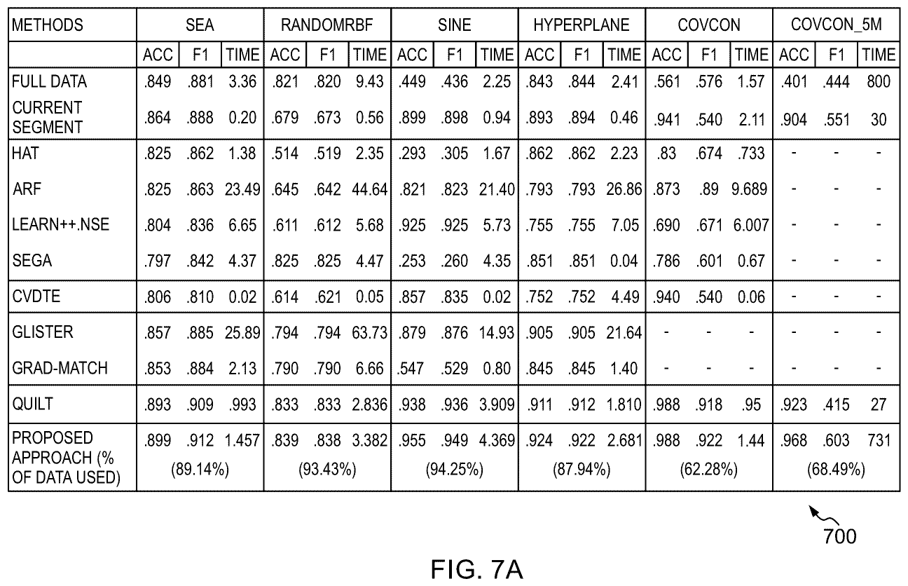

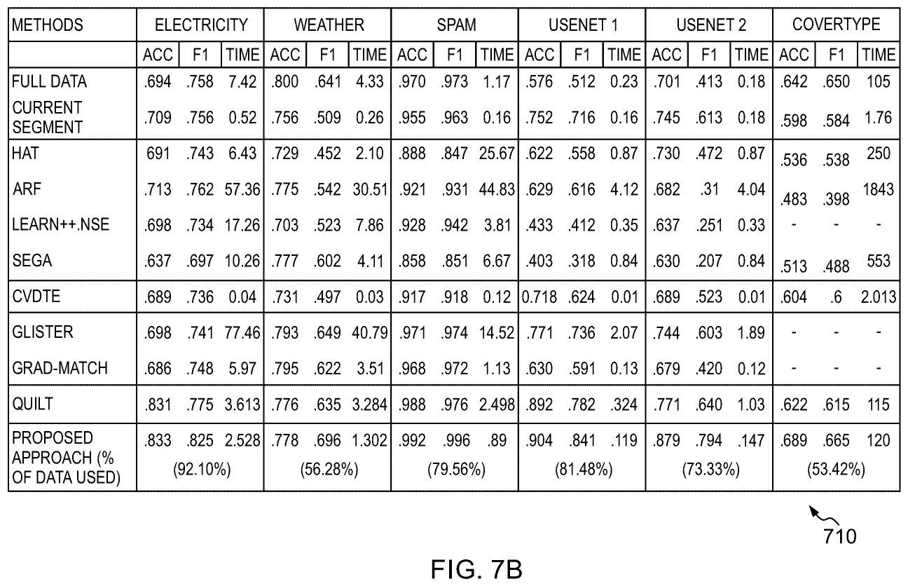

FIG. 7A illustrates a tabular representation 700 of experimental results for synthetic datasets, in accordance with an embodiment of the present disclosure. FIG. 7B illustrates a tabular representation 710 of experimental results for real-world datasets, in accordance with an embodiment of the present disclosure. In a non-limiting implementation, several experiments have been conducted using a varied selection of datasets, including five synthetic and five real-world datasets. Table 2 provides detailed descriptions and summary statistics for each dataset used in the experiments. It is noted that the results shown in Table 2 are approximate in nature and may vary by a factor of +5% due to various experimental conditions.

TABLE 2
Dataset statistics

| | | | | | | | Num. | |
|---|---|---|---|---|---|---|---|---|
| | | | | | | | batches | |
| | | | | | Num. | Segment | per | Batch |
| Type | Dataset | Size | Features | Classes | Segments | size | segment | size |
| Synthetic | SEA | 16K | 3 | 2 | 8 | 2K | 20 | 100 |
| | Random RBF | 16K | 10 | 2 | 8 | 2K | 20 | 100 |
| | Sine | 16K | 4 | 2 | 8 | 2K | 20 | 100 |
| | Hyperplane | 16K | 10 | 2 | 8 | 2K | 20 | 100 |
| | Covcon | 10K | 2 | 2 | 5 | 2K | 2 | 1K |
| | Covcon_5M | 5M | 2 | 2 | 10 | 500K | 10 | 50K |
| Real | Electricity | 43.2K | 6 | 2 | 10 | 4.32K | 20 | 216 |
| | Weather | 18K | 8 | 2 | 10 | 1.8K | 20 | 90 |
| | Spam | 9.3K | 499 | 2 | 10 | 1.036K | 14 | 74 |
| | Usenet1 | 1.5K | 99 | 2 | 9 | 300 | 2 | 150 |
| | Usenet2 | 1.5K | 99 | 2 | 5 | 300 | 3 | 100 |
| | Covertype | 581K | 54 | 7 | 10 | 58.1K | 10 | 5.81K |

It may be noted that, in a non-limiting implementation, the synthetic datasets are deliberately crafted to represent different forms of concept drift. Also, it is not that all datasets except Covcon are taken and preprocessed. Various examples of the synthetic datasets include a Streaming Ensemble Algorithm (SEA) dataset, a Random Radial Basis Function (RBF) dataset, a sine dataset, a hyperplane dataset, a Covcon dataset, a Covcon_5M dataset, and the like. It is noted that the SEA dataset is a standard dataset for simulating sudden concept drifts. The samples are in a three-dimensional (3D) feature space with random numeric values between 0 and 10. Further, the Random RBF dataset is used to make a number of random centroids and new samples are generated by selecting the center of centroids. Furthermore, the sine dataset contains four numerical features with values that range from 0 to 1. Two of the features are relevant to a given binary classification task, while the two other features simulate noise. The hyperplane dataset is viewed as concepts and varied orientations that are used to simulate drifts. A hyperplane is defined by feature weights, and weights drift over time. There are ten relevant features, including two drift features. Furthermore, the Covcon dataset and the Covcon 5M dataset are 2-dimensional (2D) datasets that have covariate shift and concept drift. The decision boundary at each point is given by α*sin (πx₁)>x₂.

Various examples of the real datasets can include an electricity dataset, a weather dataset, a spam dataset, a usenet1 dataset, a usenet2 dataset, a covertype dataset, and the like. The electricity dataset is Australian New South Wales Electricity Market data from 1996 to 1998, measured every 30 minutes. Further, the weather dataset includes data points that measure the weather in Bellevue NE, during the period of 1949-1999. The spam dataset consists of email messages from the Spam Assassin Collection. There are 9,324 samples of messages, and a message is represented by 499 features of a Boolean bag-of-words. The labels denote whether a message is spam or not. Furthermore, the Usenet1 and 2 datasets are two real datasets that are based on the 20 newsgroup collection with three topics: medicine, space, and baseball. Each sample contains messages about different topics, and a user labels them sequentially by personal interests, whether the topic of a message is interesting (1) or junk (0). Moreover, the covertype dataset contains 581K samples describing 7 forest cover types for 4 regions in the Roosevelt National Forest.

It is noted that for each dataset, the various experiments conducted provide results, such as accuracy, F1 score, and runtime results for the proposed approach by setting the last (latest) segment as the current segment. This means that the most recent segment of data is used to evaluate how well the proposed approach performs in a real-world scenario where data is continuously evolving. The proposed approach may be compared with other baseline methods across all ten datasets, as shown in FIG. 7A and FIG. 7B. It is noted that the results shown in FIG. 7A and FIG. 7B are approximate in nature and may vary by a factor of ±5% due to various experimental conditions.

Referring to the results in FIG. 7A and FIG. 7B, it may be observed that the proposed approach consistently outperforms all the baselines in terms of accuracy. This superior performance is attributed to the effective utilization of drifted data by the proposed approach, which allows it to maintain high accuracy even when the data distribution changes over time.

It is noted that the various experiments are conducted by using the public codebase of Quilt to get the results of all baselines. Also, it is noted that for the sake of conducting the experiments, a Random Forest to partition (Algorithm 1) and rank batches of the data segment based on a specified batch size is utilized for the ranking process 306 to eliminate the covariate drift. Then, a simple NN classifier trained using the cross-entropy loss is used to implement the filtering process 304 to deal with the concept drift (Algorithm 2).

As an experimental setup, for a random forest, a grid search over batch size [grid over 3-5 values], number of estimators nₑₛₜᵢₘₐₜₒᵣₛ, maximum depth dₘₐₓ have been used. For all the experiments, nₑₛₜᵢₘₐₜₒᵣₛ=50 and maximum depth dₘₐₓ=20. Batch size is reported in Table 2. In Algorithm 2, a NN classifier with a single hidden layer with 256 nodes is employed. The value of a disparity threshold for each data segment is calculated using Bayesian optimization with the search interval in (0,2). The learning rate is set to 1×10⁻³ and early stopping with patience 10 is used for termination, with a maximum number of epochs limited to 2000. For computation, RTX Quadro with 24 GB of VRAM and 32 GB of RAM on a Linux machine has been used. The codebase is developed using PyTorch. The subset selection method discards the segments based on gain and disparity scores. Further, only relevant batches from the remaining segments are selected, leading to a reduction in data used for training, thereby obtaining the refined training dataset. This value for each dataset is reported in FIG. 7A and FIG. 7B on the last line ‘% of data used’.

In comparison, the Full Data method, which uses all available data, including drifted data, does not perform as well as the proposed approach, because it is forced to incorporate data that may no longer be relevant to the current segment. On the other hand, the Current Segment method (i.e., the proposed approach), which only uses the most recent segment of data, fails to leverage valuable historical data, leading to lower accuracy. Hoeffding Adaptive Tree (HAT) classifier, another baseline, performs worse than the proposed approach because it adaptively learns from recent data without using previous models or historical data, limiting its ability to adapt effectively to data drift. The ensemble methods, including the Adaptive Random Forest (ARF) classifier, Learn++.NSE, and SEGA, have also underperformed compared to the proposed approach. ARF, for example, can lose useful previous knowledge when replacing an obsolete tree for drift adaptation, which negatively impacts its performance. Learn++.NSE and SEGA attempt to save all past models or a buffer's worth of them and use the current data segment to create ensembles. However, these models, trained on the previous data segments, struggle to fit the current data segment accurately with simple ensemble techniques. Cross-Validation Decision Tree Ensemble (CVDTE) classifier, another baseline, performs worse than the proposed approach because it simply collects samples that do not have conflicting predictions, regardless of whether these samples actually benefit model accuracy. This method overlooks the importance and effectiveness of the samples gathered in enhancing the model's accuracy on the present data segment. Among the data subset selection methods, GLISTER's targeted sample selection demonstrates more consistency.

To conclude, it may be understood that the proposed approach has addressed the critical issue of data drift in ML models such as the ML model 222 by introducing a novel, scalable, and flexible framework. The proposed approach integrates data-centric approaches with adaptive management of both covariate and concept drift. Further, it employs advanced data segmentation techniques to identify optimal data batches that reflect test data patterns, ensuring models remain relevant and accurate over time. The proposed approach also enhances model robustness by including drifted data in the training process, minimizes resource consumption, and reduces computational overhead, leading to significant cost savings. The experimental results observed on the synthetic and real datasets demonstrate significant improvements in accuracy, operational cost reduction, and faster ML inference compared to state-of-the-art or conventional solutions.

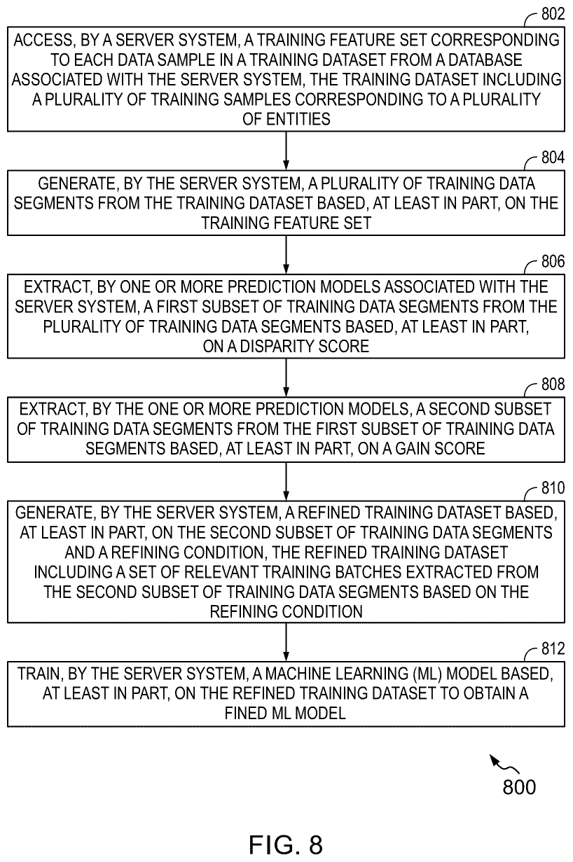

FIG. 8 illustrates a flow diagram depicting a method 800 for refining a training dataset for training an ML model (e.g., the ML model 222), in accordance with an embodiment of the present disclosure. The method 800 depicted in the flow diagram may be executed by, for example, the server system 200. The sequence of operations of the method 800 may not necessarily be executed in the same order as they are presented. Further, one or more operations may be grouped and performed in the form of a single step, or one operation may have several sub-steps that may be performed in parallel or in a sequential manner. Operations of the method 800, and combinations of operations in the method 800, may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At step 802, the method 800 includes accessing, by a server system (e.g., the server system 200), a training feature set corresponding to each data sample in a training dataset (e.g., the training dataset 302) from a database (e.g., the database 204) associated with the server system 200. The training dataset 302 may include a plurality of training samples corresponding to a plurality of entities such as the entities 104.

At step 804, the method 800 includes generating, by the server system 200, a plurality of training data segments (e.g., the training data segments 402) from the training dataset 302 based, at least in part, on the training feature set.

At step 806, the method 800 includes extracting, by one or more prediction models (e.g., the first prediction model 220(1)) associated with the server system 200, a first subset of training data segments (e.g., the remaining segments 410) from the plurality of training data segments (e.g., the training data segments 402) based, at least in part, on a disparity score (e.g., the disparity score 404).

At step 808, the method 800 includes extracting, by the one or more prediction models (e.g., the first prediction model 220(1)), a second subset of training data segments (e.g., the segments 412) from the first subset of training data segments (e.g., the remaining segments 410) based, at least in part, on a gain score (e.g., the gain score 408).

At step 810, the method 800 includes generating, by the server system 200, a refined training dataset (e.g., the refined training dataset 308) based, at least in part, on the second subset of training data segments (e.g., the segments 412) and the refining condition. The refined training dataset 308 may include a set of relevant training batches extracted from the second subset of training data segments (e.g., the segments 412) based on the refining condition.

At step 812, the method 800 includes training, by the server system 200, a Machine Learning (ML) model based, at least in part, on the refined training dataset 308 to obtain a refined ML model (e.g., the refined ML model 320).

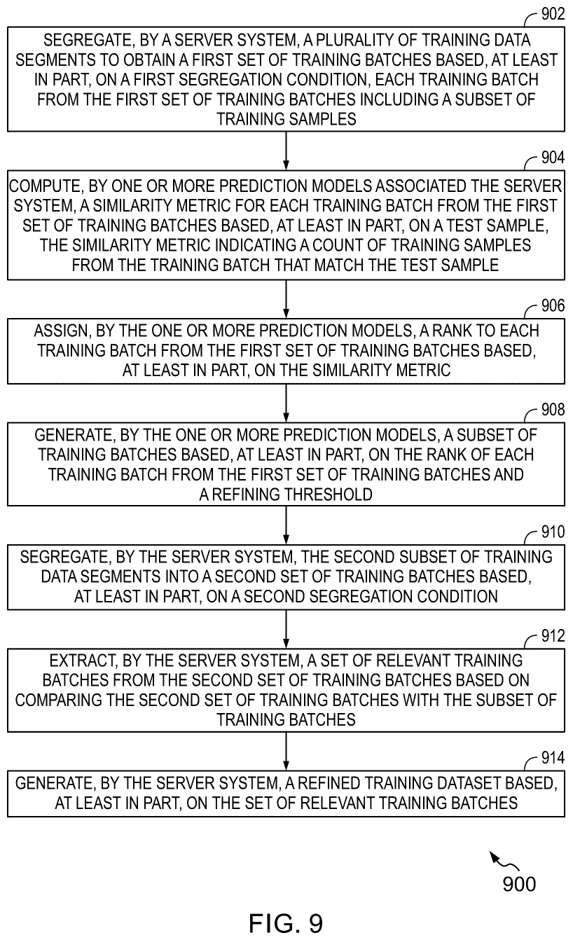

FIG. 9 illustrates a flow diagram depicting a process 900 of generating a refined training dataset (e.g., the refined training dataset 308), in accordance with an embodiment of the present disclosure. The method 900 depicted in the flow diagram may be executed by, for example, the server system 200. The sequence of operations of the method 900 may not necessarily be executed in the same order as they are presented. Further, one or more operations may be grouped and performed in the form of a single step, or one operation may have several sub-steps that may be performed in parallel or in a sequential manner. Operations of the method 900, and combinations of operations in the method 900 may be implemented by, for example, hardware, firmware, a processor, circuitry, and/or a different device associated with the execution of software that includes one or more computer program instructions. The plurality of operations is depicted in the process flow of the method 900. The process flow starts at operation 802.

At step 902, the method 900 includes segregating, by a server system (e.g., the server system 200), a plurality of training data segments (e.g., the training data segments 402) to obtain a first set of training batches (or the batches) based, at least in part, on a first segregation condition. Each training batch from the first set of training batches may include a subset of training samples.

At step 904, the method 900 includes computing, by one or more prediction models (e.g., the second prediction model 220(2)) associated with the server system 200, a similarity metric for each training batch from the first set of training batches based, at least in part, on a test sample (e.g., the test point 504). The similarity metric may indicate a count of training samples from the training batch that match the test sample (e.g., the test point 504).

At step 906, the method 900 includes assigning, by the one or more prediction models (e.g., the second prediction model 220(2)), a rank to each training batch from the first set of training batches based, at least in part, on the similarity metric.

At step 908, the method 900 includes generating, by the one or more prediction models (e.g., the second prediction model 220(2)), a subset of training batches (e.g., the ranked batches 314) based, at least in part, on the rank of each training batch from the first set of training batches and a refining threshold.

At step 910, the method 900 includes segregating, by the server system 200, the second subset of training data segments (e.g., the segments 412) into a second set of training batches (or the filtered batches) based, at least in part, on a second segregation condition.

At step 912, the method 900 includes extracting, by the server system 200, a set of relevant training batches (e.g., the best batches 316) from the second set of training batches (e.g., the segments 412) based on comparing the second set of training batches (e.g., the segments 412) with the subset of training batches (e.g., the ranked batches 314).

At step 914, the method 900 includes generating, by the server system 200, the refined training dataset 308 based, at least in part, on the set of relevant training batches (e.g., the best batches 316).

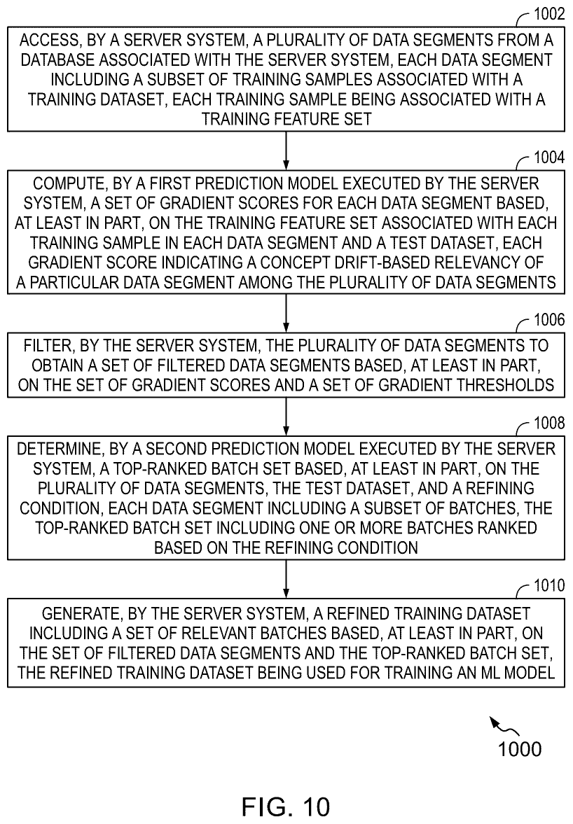

FIG. 10 illustrates a flow diagram depicting a method 1000 for refining a training dataset for training an ML model (e.g., the ML model 222), in accordance with an embodiment of the present disclosure. The method 1000 depicted in the flow diagram may be executed by, for example, the server system 200. The sequence of operations of the method 1000 may not necessarily be executed in the same order as they are presented. Further, one or more operations may be grouped and performed in the form of a single step, or one operation may have several sub-steps that may be performed in parallel or in a sequential manner. Operations of the method 1000, and combinations of operations in the method 1000 may be implemented by, for example, hardware, firmware, a processor, circuitry, and/or a different device associated with the execution of software that includes one or more computer program instructions. The plurality of operations is depicted in the process flow of the method 1000. The process flow starts at operation 1002.

At step 1002, the method 1000 includes accessing, by a server system (e.g., the server system 200), a plurality of data segments (e.g., the data segments 402) from a database (e.g., the database 204) associated with the server system 200. Each data segment includes a subset of training samples associated with a training dataset (e.g., the training dataset 302). Each training sample is associated with a training feature set. The details of the step of accessing the data segments are provided, for example, the description of FIG. 1, FIG. 2, FIG. 3, FIG. 4, FIG. 5, FIG. 6A, FIG. 6B, FIG. 7A, FIG. 7B, FIG. 8, and/or FIG. 9.

At step 1004, the method 1000 includes computing, by a first prediction model (e.g., the first prediction model 220(1)) executed by the server system 200, a set of gradient scores for each data segment based, at least in part, on the training feature set associated with each training sample in each data segment and a test dataset. Each gradient score indicates a concept drift-based relevancy of a particular data segment among the plurality of data segments (e.g., the data segments 402). The details of the step of computing the set of gradient scores are provided, for example, the description of FIG. 1, FIG. 2, FIG. 3, FIG. 4, FIG. 5, FIG. 6A, FIG. 6B, FIG. 7A, FIG. 7B, FIG. 8, and/or FIG. 9.

At step 1006, the method 1000 includes filtering, by the server system 200, the plurality of data segments (e.g., the data segments 402) to obtain a set of filtered data segments (e.g., the segments 412) based, at least in part, on the set of gradient scores (e.g., the disparity score 404 and the gain score 408) and a set of gradient thresholds. The details of the step of filtering the data segments 402 are provided, for example, the description of FIG. 1, FIG. 2, FIG. 3, FIG. 4, FIG. 5, FIG. 6A, FIG. 6B, FIG. 7A, FIG. 7B, FIG. 8, and/or FIG. 9.

At step 1008, the method 1000 includes determining, by a second prediction model (e.g., the second prediction model 220(2)) executed by the server system 200, a top-ranked batch set based, at least in part, on the plurality of data segments (e.g., the data segments 402), the test dataset, and a refining condition. Each data segment includes a subset of batches. The top-ranked batch set includes one or more batches ranked based on the refining condition. The details of the step of determining the top-ranked batch set are provided, for example, the description of FIG. 1, FIG. 2, FIG. 3, FIG. 4, FIG. 5, FIG. 6A, FIG. 6B, FIG. 7A, FIG. 7B, FIG. 8, and/or FIG. 9.

At step 1010, the method 1000 includes generating, by the server system 200, a refined training dataset (e.g., the refined training dataset 308) including a set of relevant batches based, at least in part, on the set of filtered data segments (e.g., the segments 412) and the top-ranked batch set. The refined training dataset is used for training an ML model (e.g., the ML model 222). The details of the step of generating the refined training dataset are provided, for example, the description of FIG. 1, FIG. 2, FIG. 3, FIG. 4, FIG. 5, FIG. 6A, FIG. 6B, FIG. 7A, FIG. 7B, FIG. 8, and/or FIG. 9.

The disclosed methods with reference to FIGS. 8, 9, and 10, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad scope of the disclosure. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different from those which are disclosed. Therefore, although the disclosure has been described based on these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a plurality of data segments from a database associated with the server system, each data segment comprising a subset of training samples associated with a training dataset, each training sample being associated with a training feature set;
computing, by a first prediction model executed by the server system, a set of gradient scores for each data segment based, at least in part, on the training feature set associated with each training sample in each data segment and a test dataset, each gradient score indicating a concept drift-based relevancy of a particular data segment among the plurality of data segments;
filtering, by the server system, the plurality of data segments to obtain a set of filtered data segments based, at least in part, on the set of gradient scores and a set of gradient thresholds;
determining, by a second prediction model executed by the server system, a top-ranked batch set based, at least in part, on the plurality of data segments, the test dataset, and a refining condition, each data segment comprising a subset of batches, the top-ranked batch set comprising one or more batches ranked based on the refining condition; and
generating, by the server system, a refined training dataset comprising a set of relevant batches based, at least in part, on the set of filtered data segments and the top-ranked batch set, the refined training dataset being used for training an ML model.

2. The method as claimed in claim 1, wherein filtering the plurality of data segments to obtain the set of filtered data segments comprises:
accessing, by the server system, a disparity score present in the set of gradient scores for each data segment of the plurality of data segments from the database, the disparity score indicating a dissimilarity extent between a data distribution of a corresponding data segment and the test dataset, contributing to the concept-drift based relevancy of the data segment; and
selecting, by the server system, one or more data segments from the plurality of data segments to obtain an intermediate set of data segments based on the corresponding disparity score being at least equal to a disparity threshold.

3. The method as claimed in claim 2, wherein filtering the plurality of data segments to obtain the set of filtered data segments comprises:
accessing, by the server system, a gain score present in the set of gradient scores for each data segment of the intermediate set of data segments from the database, the gain score indicating a similarity extent between the data distribution of the corresponding data segment and the test dataset, contributing to the concept-drift based relevancy of the data segment; and
selecting, by the server system, one or more data segments from the intermediate set of data segments to obtain the set of filtered data segments based on the corresponding gain score being at least equal to a gain threshold.

4. The method as claimed in claim 1, wherein determining the top-ranked batch comprises:
segregating, by the server system, the plurality of data segments to obtain a plurality of batches based, at least in part, on a first segregation condition, the plurality of batches comprising the subset of batches;
computing, by the second prediction model, a similarity metric for each batch from the plurality of batches based, at least in part, on a particular test sample from the test dataset, the similarity metric indicating a count of training samples from a corresponding batch that match the corresponding test sample;
assigning, by the server system, a rank to each batch from the plurality of batches based, at least in part, on the similarity metric and the refining condition, the rank indicating an extent of a covariate shift among the plurality of batches of the training dataset;
arranging, by the server system, the plurality of batches in a predefined order based on the rank associated with each batch of the plurality of batches; and
selecting, by the server system, one or more batches from the plurality of batches to obtain the top-ranked batch set based on a refining threshold and the corresponding rank.

5. The computer-implemented method as claimed in claim 1, wherein generating the refined training dataset comprises:
segregating, by the server system, the set of filtered data segments into a set of filtered batches based, at least in part, on a second segregation condition; and
identifying, by the server system, the set of relevant batches from the top-ranked batches to obtain the refined training dataset based, at least in part, on comparison of the top-ranked batch set with the filtered set of batches.

6. The method as claimed in claim 1, wherein computing the set of gradient scores for each data segment comprises:
computing, by the first prediction model, a disparity score for each data segment based, at least in part, on the training feature set associated with each training sample in a corresponding data segment and the test dataset, the set of gradient scores comprising the disparity score for each data segment; and
computing, by the first prediction model, a gain score for each data segment of an intermediate set of data segments to obtain the set of gradient scores based, at least in part, on the training feature set associated with each training sample in each data segment of the intermediate set of data segments and the test dataset.

7. The method as claimed in claim 6, wherein computing the disparity score for each data segment comprises:
training, by the server system, the first prediction model by iteratively performing a set of operations for the plurality of data segments until predefined criteria are met, the first prediction model being initialized using one or more model parameters, the set of operations comprising:
computing a training gradient component for each training sample in each data segment based, at least in part, on the training feature set associated with the corresponding training sample;
computing a test gradient component for each test sample in the test dataset based, at least in part, on a test feature set associated with each test sample;
computing the disparity score for each data segment based, at least in part, on the training gradient component of each training sample in the corresponding data segment, the test gradient component of each test sample, and a disparity score computation function; and
optimizing the one or more model parameters based, at least in part, on backpropagation of the training gradient component.

8. The method as claimed in claim 7, wherein computing the training gradient component for each training sample in the data segment comprises:
generating an embedding for each training sample based, at least in part, on the training feature set associated with the corresponding training sample;
generating, by the first prediction model, a probability score for each training sample based, at least in part, on the embedding associated with the corresponding training sample, the probability score indicating a likelihood that the training sample belongs to a particular class label;
generating, by the first prediction model, a prediction for each training sample based, at least in part, on the probability score, the prediction indicating a predicted class label of the training sample;
computing a loss for each training sample based, at least in part, on the predicted class label and a true label; and
computing the training gradient component for each training sample based, at least in part, on the loss of the corresponding training sample.

9. The method as claimed in claim 7, wherein computing the test gradient component for each test sample comprises:
generating, by the server system, an embedding for each test sample based, at least in part, on the test feature set associated with the corresponding test sample;
generating, by the first prediction model, a probability score for each test sample based, at least in part, on the embedding associated with the corresponding test sample, the probability score indicating a likelihood that the corresponding test sample belongs to a particular class label;
generating, by the first prediction model, a prediction for each test sample based, at least in part, on the probability score, the prediction indicating a predicted class label of the corresponding test sample;
computing a loss for each test sample based, at least in part, on the predicted class label and a true label; and
computing the test gradient component for each test sample based, at least in part, on the loss of the corresponding test sample.

10. The method as claimed in claim 6, wherein computing the gain score for each data segment of the intermediate set of data segments comprises:
training, by the server system, the first prediction model by iteratively performing a set of operations for the intermediate set of data segments until predefined criteria are met, the first prediction model being initialized using one or more model parameters, the set of operations comprising:
computing a training gradient component for each training sample in each data segment of the intermediate set of data segments based, at least in part, on the training feature set associated with the corresponding training sample;
computing a test gradient component for each test sample in the test dataset based, at least in part, on a test feature set associated with each test sample; and
computing the gain score for each data segment of the intermediate set of data segments based, at least in part, on the training gradient component of each training sample in the corresponding data segment, the test gradient component of each test sample, and a gain score computation function.

11. The computer-implemented method as claimed in claim 1, further comprising:
accessing, by the server system, an entity-related dataset from the database, the entity-related dataset comprising information related to a plurality of entities;
generating, by the server system, a feature set corresponding to each data sample in the entity-related dataset based, at least in part, on the information related to the plurality of entities; and
storing, by the server system, the feature set in the database.

12. The method as claimed in claim 1, further comprising:
receiving, by the server system, a training request message for training the ML model from a managing entity;
accessing, by the server system, the refined training dataset from the database;
training, by the server system, the ML model to obtain a trained ML model based, at least in part, on the refined training dataset; and
transmitting, by the server system, the trained ML model to the managing entity, the trained ML model being trained to generate a prediction related to a downstream task.

13. A server system, comprising:
a memory configured to store instructions;
a communication interface; and
a processor in communication with the memory and the communication interface, the processor configured to execute the instructions stored in the memory and thereby cause the server system to perform at least in part to:
access a plurality of data segments from a database associated with the server system, each data segment comprising a subset of training samples associated with a training dataset, each training sample being associated with a training feature;
compute, by a first prediction model executed by the server system, a set of gradient scores for each data segment based, at least in part, on the training feature set associated with each training sample in each data segment and a test dataset, each gradient score indicating a concept drift-based relevancy of a particular data segment among the plurality of data segments;
filter the plurality of data segments to obtain a set of filtered data segments based, at least in part, on the set of gradient scores and a set of gradient thresholds;
determine, by a second prediction model executed by the server system, a top-ranked batch set based, at least in part, on the plurality of data segments and the test dataset, each data segment comprising a subset of batches, the top-ranked batch set comprising one or more batches ranked based on the refining condition; and
generate a refined training dataset including a set of relevant batches based, at least in part, on the set of filtered data segments and the top-ranked batch set, the refined training dataset being used for training an ML model.

14. The server system as claimed in claim 13, wherein to filter the plurality of data segments to obtain the set of filtered data segments, the server system is caused, at least in part, to:
access a disparity score present in the set of gradient scores for each data segment of the plurality of data segments from the database, the disparity score indicating a dissimilarity extent between a data distribution of the data segment and the test dataset, contributing to the concept-drift based relevancy of the data segment; and
select one or more data segments from the plurality of data segments to obtain an intermediate set of data segments based on a corresponding disparity score being at least equal to a disparity threshold.

15. The server system as claimed in claim 14, wherein to filter the plurality of data segments to obtain the set of filtered data segments, the server system is further caused, at least in part, to:
access a gain score present in the set of gradient scores for each data segment of the intermediate set of data segments from the database, the gain score indicating a similarity extent between a data distribution of the data segment and the test dataset, contributing to the concept-drift based relevancy of the data segment; and
select one or more data segments from the intermediate set of data segments to obtain the set of filtered data segments based on a corresponding gain score being at least equal to a gain threshold.

16. The server system as claimed in claim 13, wherein to determine the top-ranked batch, the server system is caused, at least in part, to:
segregate the plurality of data segments of the training dataset to obtain a plurality of batches based, at least in part, on a first segregation condition, the plurality of batches comprising the subset of batches;
compute, by the second prediction model, a similarity metric for each batch from the plurality of batches based, at least in part, on a particular test sample from the test dataset, the similarity metric indicating a count of training samples from a corresponding batch that match the corresponding test sample;
assign a rank to each batch from the plurality of batches based, at least in part, on the similarity metric and the refining condition, the rank indicating an extent of a covariate shift among the plurality of batches of the training dataset;
arrange the plurality of batches in a predefined order based on the rank associated with each batch of the plurality of batches;
determine the top-ranked batch set based, at least in part, on the rank of each batch of the plurality of batches and a refining threshold; and
select one or more batches from the plurality of batches to obtain the top-ranked batch set based on a refining threshold and the corresponding rank.

17. The server system as claimed in claim 13, wherein to compute the set of gradient scores for each data segment, the server system is caused, at least in part, to:
compute, by the first prediction model, a disparity score for each data segment based, at least in part, on the training feature set associated with each training sample in a corresponding data segment and the test dataset, the set of gradient scores comprising the disparity score for each data segment; and
compute, by the first prediction model, a gain score for each data segment of an intermediate set of data segments to obtain the set of gradient scores based, at least in part, on the training feature set associated with each training sample in each data segment of the intermediate set of data segments and the test dataset.

18. The server system as claimed in claim 17, wherein to compute the disparity score for each data segment, the server system is caused, at least in part, to:
train the first prediction model by iteratively performing a set of operations for the plurality of data segments until predefined criteria are met, the first prediction model being initialized using one or more model parameters, the set of operations comprising:
compute a training gradient component for each training sample in each data segment based, at least in part, on the training feature set associated with the corresponding training sample;
compute a test gradient component for each test sample in the test dataset based, at least in part, on a test feature set associated with each test sample;
compute the disparity score for each data segment based, at least in part, on the training gradient component of each training sample in the corresponding data segment, the test gradient component of each test sample in the test dataset, and a disparity score computation function; and
optimize the one or more model parameters based, at least in part, on backpropagation of the training gradient component.

19. The server system as claimed in claim 17, wherein to compute the gain score for each data segment of the intermediate set of data segments, the server system is caused, at least in part, to:
train the first prediction model by iteratively performing a set of operations for the intermediate set of data segments until predefined criteria are met, the first prediction model being initialized using one or more model parameters, the set of operations comprising:
compute a training gradient component for each training sample in each data segment of the intermediate set of data segments based, at least in part, on the training feature set associated with the corresponding training sample;
compute a test gradient component for each test sample in the test dataset based, at least in part, on a test feature set associated with each test sample; and
compute the gain score for each data segment of the intermediate set of data segments based, at least in part, on the training gradient component of each training sample in the corresponding data segment, the test gradient component of each test sample, and a gain score computation function.

20. A non-transitory computer-readable storage medium comprising computer-executable instructions that, when executed by at least a processor of a server system, cause the server system to perform a method comprising:
accessing a plurality of data segments from a database associated with the server system, each data segment comprising a subset of training samples associated with a training dataset, each training sample being associated with a training feature set;
computing, by a first prediction model executed by the server system, a set of gradient scores for each data segment based, at least in part, on the training feature set associated with each training sample in each data segment and a test dataset, each gradient score indicating a concept drift-based relevancy of a particular data segment among the plurality of data segments;
filtering the plurality of data segments to obtain a set of filtered data segments based, at least in part, on the set of gradient scores and a set of gradient thresholds;
determining, by a second prediction model executed by the server system, a top-ranked batch set based, at least in part, on the plurality of data segments, the test dataset, and a refining condition, each data segment comprising a subset of batches, the top-ranked batch set comprising one or more batches ranked based on the refining condition; and
generating a refined training dataset comprising a set of relevant batches based, at least in part, on the set of filtered data segments and the top-ranked batch set, the refined training dataset being used for training an ML model.
